(19) United States
(12) Patent Application Publication
(10) Pub. No.: US 2004/0125472 A1
(43) Pub. Date: Jul. 1, 2004

(54) Actuated deformable membrane mirror

(76) Inventor: R. Todd Belt, Mountain View, CA (US)

Correspondence Address: PATENT LAW OFFICES OF DAVID MILLERS, 6560 ASHFIELD COURT, SAN JOSE, CA, 95120, US

(21) Appl. No.: 10/734,699

(22) Filed: Dec. 12, 2003

Related U.S. Application Data
(60) Provisional application No. 60/433,349, filed on Dec. 12, 2002.

(51) Int. Cl. G02B 26/08

(52) U.S. Cl. 359/847; 359/849

(57) ABSTRACT

Structures including piezoelectric actuators, actuator arrays, and deformable mirrors and processes for fabricating the structures are provided. The fabrication processes can manufacture arrays of actuators including piezoelectric materials using wafer-processing techniques. The actuators include piezoelectric layers sandwiched between electrodes that are mounted on flexures that provide electrical connections. The piezoelectric layers can be formed on sacrificial layers while flexures are formed in trenches or vias through the sacrificial layers. Removal of the sacrificial layers frees the piezoelectric layer and permits the piezoelectric layers to dish or warp when providing the actuator action. Alternative embodiments include actuators that are bimorphs or Rainbows.

### CROSS-REFERENCE TO RELATED APPLICATION

This patent document claims benefit of the earlier filing date of U.S. Provisional patent application 60/433,349, filed Dec. 12, 2002, which is hereby incorporated by reference in its entirety.

### BACKGROUND

Adaptive optical (AO) systems are growing in importance. Such adaptive optical systems particularly can correct wavefront irregularities (or phase errors) that pose substantial problems for imaging and laser power delivery. The classic example of wavefront irregularities is the twinkling that terrestrial observers see when viewing stars. For terrestrial observatories, irregularities in Earth's atmosphere cause twinkling, which results in a “twinkle” or mottled image, rather than a clear image of the objects being observed. Wavefront irregularities are not, however, limited to astronomical telescopes. Other high precision optical systems such as photolithography systems, remote sensors (astronomical and terrestrial), and directed energy weapons (i.e., high power lasers) similarly need minimal phase errors for optimal performance. In all of these systems, wavefront correction could offer improvements in system performance.

Adaptive optical systems capable of correcting wavefront irregularities were initially developed for terrestrial astronomy. FIG. 1 illustrates a conventional AO system 100 including a wavefront sensor 110, a control processor 120, and a deformable mirror (DM) 130. In AO system 100, wavefront sensor 110, which is typically referred to as a Hartmann-Shack sensor, measures the irregularities or phase errors in light reflected from deformable mirror 130. Processor 120 analyzes the measurement signal from sensor 110 and controls the shape of deformable mirror 130 to eliminate the measured wavefront irregularities.

Wavefront sensors generally discretize the wavefront via a lenslet array in front of a focal plane array. The focal plane array can be any array of photoelectric sensing element such as a CCD sensor array in a digital camera. Wavefront sensors are a relatively recent development, mainly because they require focal plane arrays and micro aperture lens arrays, both of which became available only recently.

Deformable mirror 130 is typically a thin mirror with an array of tightly packed piston actuators. The actuators are typically stacks of piezoelectric disks, which are manufactured with classic manufacturing methods requiring manual construction. Thus, the actuators are devices with minimum diameters on the order of 1 cm, and a complete array of actuators has a typical diameter of about 10 cm. The actuators, being stacked piezoelectric actuators, have heights (or lengths) that are typically on the order of 10 cm. Accordingly, these DMs are large, heavy, and expensive devices, and their lower bound of spatial resolution is about 1 cm. The size and cost of deformable mirrors have not been insurmountable for observatories, but they are extremely limiting for extensive deployment of directed energy weapons and line-of-sight laser communication.

Microelectromechanical systems (MEMS) have been developed for micromechanical control. MEMS have several advantages. One advantage is that the fabrication techniques for MEMS allow miniaturization that human hands operating with a microscope cannot achieve. MEMS also allow compact integration of comprehensive functionality. At this early stage in the development of MEMS, most of the research has been into miniaturization of discrete transducers. Once the field has developed, the promise is that the transducers and their corresponding electronics may be built monolithically using integrated circuit manufacturing techniques. Manufacturing techniques for MEMS can also be adapted for mass fabrication with high repeatability of performance.

In view of the state of the art, methods and structures for combining the features of MEMS into a deformable mirror and other adaptive optics are sought.

### SUMMARY

In accordance with an aspect of the invention, a deformable mirror employs microelectromechanical systems (MEMS) for control of mirror topology. In one embodiment of the invention, an actuator employs piezoelectric material that dishes or warps in response to an applied electric field, and thus provides a greater stroke than would be possible relying purely on the expansion of a piezoelectric material.

In accordance with another embodiment of the invention, a microelectromechanical actuator includes a region of piezoelectric material held at its perimeter by flexures. The flexures provide electrical connections and hold the region so that the region dishes or warps when an electric field is applied. In alternative embodiments, the piezoelectric material held by the flexures can be a bimorph, a RAINBOW, or other piezoelectric actuator. The flexures can be attached to a rigid frame. Making the frame hexagonal facilitates arranging the actuators into a hexagonal array for use in a deformable mirror.

In accordance with yet another aspect of the invention, processes for manufacturing deformable mirrors or microelectromechanical actuators are provided. The fabrication process can employ wafer processing techniques, and in particular, patterns electrode and insulating layers to form flexures that are attached to regions of piezoelectric material. The piezoelectric material can be deposited conformally using sputtering or other processing techniques and patterned to form regions (typically disk) corresponding to separate actuators in an array. The flexures are at a limited number of points around the perimeter of the piezoelectric regions, so that an etching process can remove a sacrificial oxide or other sacrificial material under the piezoelectric regions.

### BRIEF DESCRIPTION OF THE DRAWINGS

FIG. 1 shows a conventional adaptive optics system such as can be employed in a terrestrial observatory.

FIGS. 2A and 2B respectively show a plan view and a perspective view of finite elements of a deformable mirror operated by actuators.

FIG. 3 shows a perovskite crystal structure unit cell for a piezoelectric material with no electric field applied.

FIG. 4 is a cross-sectional view of a RAINBOW piezoelectric actuator.

FIG. 5 is a cross-sectional view of a bimorph piezoelectric actuator.

FIGS. 6A, 6B, and 6C are perspective views of portions of an actuator in accordance with an embodiment of the invention having a piezoelectric disk supported by flexures.

FIGS. 7A to 7O are cross-sectional views of structures created during a fabrication process in accordance with an embodiment of the invention including an array of bimorph actuators.

FIGS. 8A to 8F are cross-sectional views of structures created during a fabrication process in accordance with another embodiment of the invention including an array of RAINBOW actuators.

FIGS. 9A to 9Q are cross-sectional views of structures created during a fabrication process in accordance with another embodiment of the invention including a bimorph actuator.

FIG. 10 is a cross-section of a portion of a RAINBOW actuator in accordance with an embodiment of the invention.

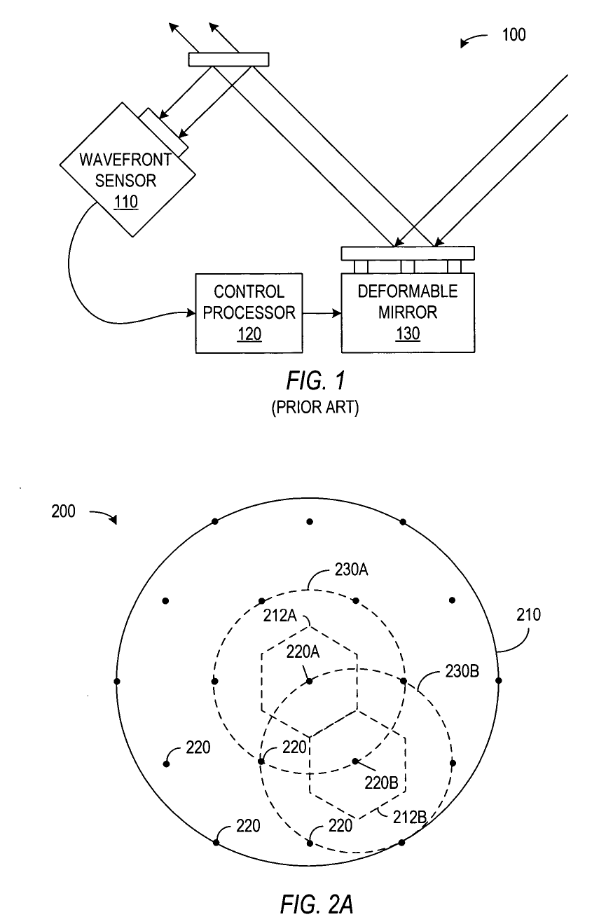

Use of the same reference symbols in different figures indicates similar or identical items.

### DETAILED DESCRIPTION

In accordance with an aspect of the invention, adaptive optical systems and particularly deformable mirrors employ microelectromechanical systems including actuator arrays. Fabrication processes in accordance with another aspect of the invention permit manufacture of the adaptive optical systems using wafer processing techniques.

Exemplary Deformable Mirror System Requirements

Deformable mirrors are applicable to a variety of systems including, for example, laser wireless communication (i.e., urban line-of-sight or building-to-building communications), and directed energy weapons. However, weapon systems have performance requirements that are likely to be most challenging. Such systems typically need to operate with less environmental protection (thermal and vibration), and the required mean time between failure (MTBF) may be orders of magnitude higher than other systems. Additionally, weapon systems typically employ light having a relatively long wavelength, which requires a long stroke for phase correction, and the transmission distance (optical path length or target distance) will likely be an order of magnitude greater than required for some other applications. Other laser weapon difficulties (which are not addressed further here) are thermal blooming of the optical path and required cooling systems.

A deformable mirror for a directed energy weapon, thus, is generally subject to the following general design constraints: (1) reflective surfaces must be continuous so that irradiance does not impinge on the underlying DM structure, (2) the mirror subassembly must minimize thermal distortion due to the high thermal impulse, (3) the actuators must provide relatively large piston stroke (maximum peak-to-valley phase correction), which is coupled with (4) a high temporal response rate, which is a function of optical path length. Thus, a deformable mirror that is suitable for a weapon system could generally be employed in other systems and is described herein as an exemplary embodiment of the invention. Applications to other systems such as wireless communication systems will be noted where relevant.

Near infrared (NIR) light, with a wavelength λ between about 1 μm to 5 μm is generally suitable for a laser weapon, and the most likely high power laser NIR wavelength is about 1 μm. A phase change of 2π thus corresponds to an optical path length of about 1 μm. When such light impinges on a reflective surface of a DM mirror, the reflective surface imparts its shape onto the impinging wavefront, but with twice the magnitude. A DM thus needs to actuate at least half the distance of the phase error, for all orders of phase error. In an exemplary embodiment, high order wavefront correction thus requires a piston actuation of about ±0.25 μm. If the pistons can deform the DM about 40 times farther than what is needed for simple high order wavefront correction (i.e., about ±10 μm as a conservative rounded estimate), the DM can also concurrently do low order wavefront correction (i.e., for pitch, yaw, and focus); which removes the need for a fast steering mirror.

The size of the DM generally required for a laser weapon depends on the size of the output beam and the properties of other optical components in the weapon. If a weapon produces a 200-mm diameter output beam through a 10× expander, relay optics including the DM will have a typical diameter of about 25 mm.

The quality to which the DM can correct a wavefront is based on its spatial resolution. Based on the beam quality requirements, the piston spacing or number of actuators is derived. One of the most rudimentary forms of beam quality assessment is in the form of the Strehl ratio (S). A Strehl ratio S greater than about 0.9 is assumed for this exemplary embodiment. For a high quality telescope this would be an excellent value. As an example, the Marechal criterion for image quality requires S>0.80, which roughly corresponds to a peak-to-valley (PV) wavefront of λ/4. Based on these values, the required spatial resolution or actuator spacing can be derived.

The rate of phase change will depend on the system, but a coherence time corresponding phase change frequency of about 1 KHz may be typical. A control system will preferably have a control signal frequency that is tens of times faster than the natural frequency, so the control system should preferably operate at least 10 KHz. This frequency response of 10 KHz is also applied in the MEMS and the mirror membrane. Each individual component in the control system loop should be faster than the system's cumulative response rate. As a side note, infrared focal plane array sensors currently have a maximum frame rate of about 10 KHz. The maximum frame rate will likely improve, but the current frame rate is sufficient.

An optomechanical rule of thumb is to design structures so that their first modal frequency is 2.5 times that of the highest frequency that the structures are expected to experience. Applying this rule of thumb with a control frequency of 10 KHz, translates into a requirement that the actuators and mirror membrane have first modal frequencies greater than about 25 KHz.

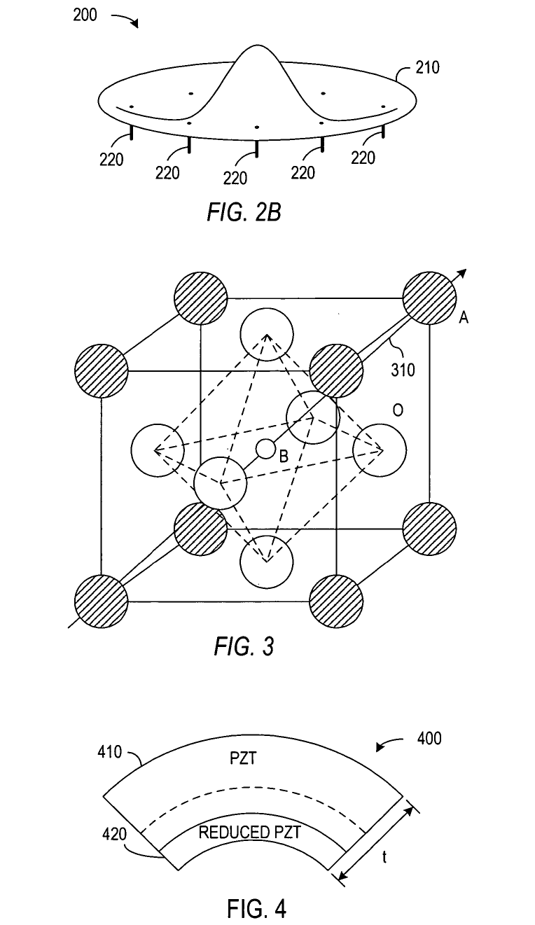

FIG. 2A is a plan view of a deformable mirror 200, which includes a mirror membrane 210 and a set of actuators 220. Mirror membrane 210 is made of a reflective material that in the embodiment of FIG. 2A is flat when actuators 220 have their unactuated lengths. Alternatively, mirror membrane 210 can have any desired unactuated shape, depending whether deformable mirror 210 serves any optical functions in addition to phase correction.

Actuators 220 are positioned on a hexagonal lattice and extend or contract to change the shape of mirror membrane 210 as required for phase correction and/or the other optical functions of deformable mirror 200. FIG. 2B shows perspective view of mirror 200 with actuators 220 extended and contracted to provide an exaggerated topology for deformable mirror 200.

Deformable mirror 200 can be considered to include an array of “differential mirror elements.” The phrase “differential mirror element” is used herein in two different contexts. The first context is the hexagonal definition that corresponds to a single actuator 220A or 220B and a hexagonal portion 212A or 212B of continuous mirror membrane 210. This definition is used in the context of an actuator-mirror element that can be combined into an array to form a DM. The second context of “differential mirror element” corresponds to the circular edge that circumscribes the axes of the six actuators 220 surrounding the actuator 220A or 220B of interest in FIG. 2A. The boundary condition created at this edge is something between fixed and simply supported by flexures as described below. The hexagonal packing is preferred since it gives the optimal packing density and is the nearest to Gaussian form, versus the typical square packing.

Mirror Membrane

The two important constraints on mirror membrane 210 are mechanical malleability and thermal diffusivity. A low malleability (or low Young's modulus) is preferred to reduce the reaction force imposed onto actuators 220, conversely a high strength to weight ratio lowers the modal frequencies dependence on the membrane thickness. The mirror membrane must also meet a natural frequency requirement, which places an upper limit on malleability. A high diffusivity is required to lower transient thermal stresses and, especially for directed energy weapons, to quickly transfer the thermal energy to a coolant.

Optical surface roughness, reflectivity, and the overall optical surface's unactuated form factor are the next constraints. A typical surface roughness RMS value for high quality commercial optics is on the order of 0.34 nm. Surface roughness effects reflectivity, and the reflectivity requirement are fairly high due to the high-energy beam. The unactuated form factor is a measure of how much wavefront is imparted by mirror membrane 210 when actuators 220 are in non-actuated positions. This can be seen as a parasitic parameter since DM 200 can compensate, but using actuators 220 to compensate for the unactuated form of mirror membrane 210 reduces the capability of DM 200. If the unactuated mirror has a form factor with a phase variance of λ/2, for example, then 0.25 μm of the stroke of some actuators 220 is consumed in making a nominally flat reflective surface.

A short list of preferred materials for the mirror membrane includes diamond, SiC, Si₃N₄, SiO₂, and indium (In). This is based on the membrane design constraints such as diffusivity, reflectance, and manufacturability. Indium's spectral response curve is similar to silver; yet it doesn't oxidize like silver, thus making indium an ideal low power DM mirror membrane. However, indium has a low melting point and may be unacceptable for high energy DMs.

Reflectance of a mirror membrane can be greatly improved with the application of high reflectance (HR) dielectric coatings. HR coatings are typically applied to a silicon-based substrate and can achieve up to 99.99% reflectance, so that only 0.01% of the light is transmitted to the substrate or absorbed by the coating. Strata of various thin films are used to create a HR coating. A typical coating might have 21 layers that are λ/4 thick, which adds up to a total HR thickness of 5.25 μm for light with a wavelength of 1 μm. The HR coating alone can be a suitable mirror membrane. If the mirror membrane's modal frequency requires additional thickness then the mirror coating can be reinforced with a silicon nitride, silicon carbide, or diamond substrate. The HR coating has a different coefficient of thermal expansion (CTE or α) from the substrate; which causes a surface form error due to shear stress. The application of a similar coating on the back surface of the membrane can mitigate the shear stress. The back coating does not need to be identical to the HR coat and can be tailored to match the stress deformation. The back coating might be 1 μm thick. The added thickness for the HR coating is about 6.25 μm for the silicon-based mirror substrates.

Actuation Selection

The actuators for an exemplary embodiment of the invention employ piezoelectric materials. Piezoelectric materials such as zinc oxide (ZnO), barium oxide (BaO), and Plumbum (lead) Zirconate Titanate (PZT) have long been known to have crystal structures that change dimensions in applied electric fields or conversely generate voltages when compressed. The ideal piezoelectric unit cell structure is the perovskite crystal structure as illustrated in FIG. 3. This cubic unit cell is of the form ABO₃, where A and B are cations and O is an anion. For PZT, cation A is lead (Pb), cation B is Ti and Zr, and anion O is oxygen. Researchers have used a wide range of the ratio of Pb and Zn (A and B) in PZT. When optimized for maximum strain response, the ratio zirconium/titanium is about 45/55.

The unit cell structure of FIG. 3 does not have an inherent pole orientation. Similar to iron, which has random magnetic dipole orientations that can be aligned with an external magnetic field to induce a semi-stable net magnetic pole, piezoelectric materials can be manufactured by applying a powerful electric field to set the net pole orientation. The preferred pole orientation 310 in terms of the perovskite unit cell is shown in FIG. 3. Using the standard crystal lattice nomenclature, this is referred to as the <111>direction. Poling in the other crystalline orientations (i.e., <100>) will have a piezoelectric effect, but the dipole is not as effective.

There are many types of piezoelectric configurations for actuators. A d₃₃ stack of piezoelectric disks is the currently preferred configuration for use in mesoscale DM's because a d₃₃ stack, which increases in thickness in response to an applied electric field, gives the largest actuation force. However, the stacked configuration requires a large stack (e.g., 100's of layers) to obtain an appreciable stroke. Large numbers of layers is anathema to thin film manufacturing. As an example, microelectronic devise having 30 layers would currently be considered highly complex.

Other configurations can develop a larger stroke, for example, by creating linear stroke from the dishing of a piezoelectric disk. A list of such actuators includes the unimorph, monomorph, bimorph, RAINBOW, and THUNDER.

A unimorph has a single layer of piezoelectric on a flexible layer, which is typically a metal foil. RAINBOW is the acronym for “reduced and internally biased oxide wafer” and is effectively a unimorph, but the metal layer is created by reduction of one side of the piezoelectric disk. The current fabrication process for a RAINBOW requires a piezoelectric from the PZT family. THUNDER is the acronym for “thin layer composite unimorph ferroelectric driver and sensor.” As the name states, a THUNDER is a multi-layer unimorph. As an example of this class of actuator, FIG. 4 illustrates the structure of a RAINBOW 400, which provides actuations through bowing caused by the difference expansion of a PZT layer 410 and a reduced PZT layer 420.

A monomorph is similar to a unimorph in construction but induces a differential moment via a non-uniform electrical field.

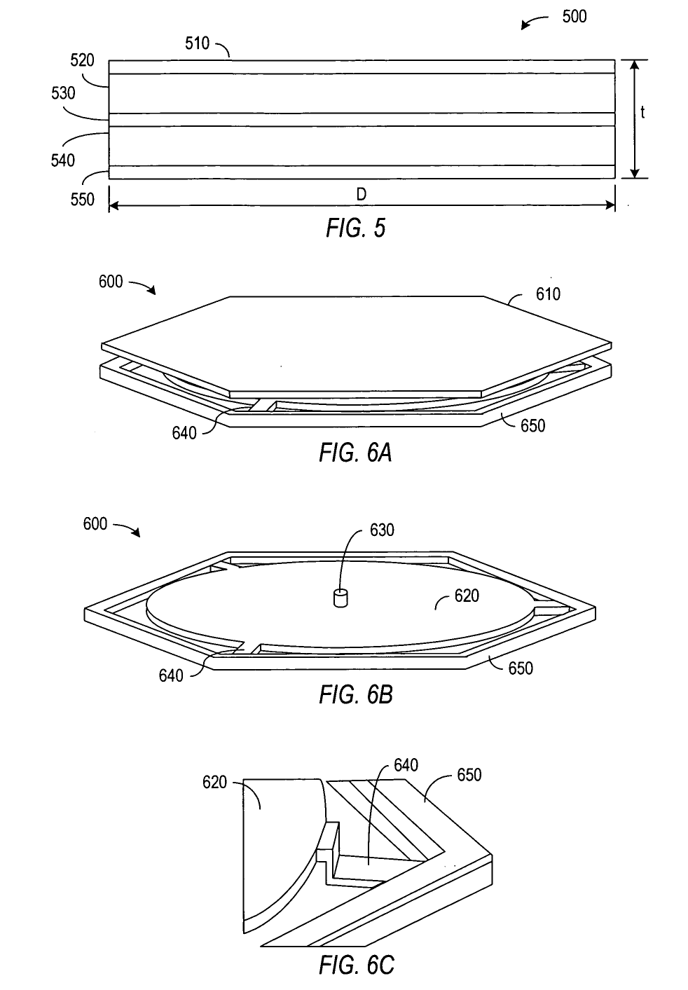

FIG. 5 shows a cross-sectional view of a bimorph 500. Bimorph 500 has two parallel piezoelectric layers 520 and 540 that are actuated in opposing compression and tension along their diameters D when electrodes 510, 530, and 550 are charged to provide opposite electric fields. As a result, one piezoelectric layer 520 or 540 expands, while the other piezoelectric layer 540 or 520 contracts, resulting in a dishing that causes the actuation.

Moonies are a type of piezoelectric actuator analogous to the type of car jack that has a central horizontal screw. In the car jack, the screw is between two opposing joints of a parallelogram. As the screw tightens, the screw shortens the distance between the two opposing joints and conversely forces the other two opposing joints farther apart. For a Moonie, the piezoelectric layer lengthens or shortens to flatten or further bow an attached dish layer. An alternative embodiment Moonie has a hinged dish layer.

Actuators Having Flexures

In accordance with an aspect of the invention, an actuator includes a piezoelectric disk mounted on flexures to increase the amount of deflection. FIGS. 6A, 6B, and 6C illustrate portions of a mirror element 600 in accordance with an embodiment of the invention including an actuator with flexures. Mirror element 600 includes a hexagonal portion 610 of a continuous mirror membrane and a piezoelectric actuator 620. A piston rod 630 on piezoelectric actuator 620 attaches to the mirror membrane, causing deformation of the mirror membrane when actuator 620 operates.

Piezoelectric actuator 620 in the illustrated embodiment is disk shaped and has a stroke that results from dishing. In exemplary embodiments of the invention, piezoelectric actuator 620 is a bimorph or a RAINBOW, but other actuator configuration might be employed.

Flexures 640 that are spaced around the perimeter of piezoelectric actuator 620 attach piezoelectric actuator 620 to a base 650. Flexures 640 additionally provide an electrical connection to electrodes in actuator 620. Flexures 640 generally are multilayer structures including one or more metal layers that are insulated from each other by intervening insulating layers. In an exemplary embodiment of the invention, where actuator 620 is a bimorph, each flexure 640 may contain strata of Pt/Si₃N₄/Pt/ Si₃N4/Pt/Ti.

Analysis of Actuator Properties

The following analyzes performance of actuators based on plate bending theory. This analysis is further based on the following assumptions: (1) the unstressed geometry of the piezoelectric disk is flat; (2) disks have constant thickness t; (3) the material is homogeneous, isotropic, and linearly elastic; (4) for a z-axis normal to the disk surface, the forces are parallel to the z-axis, and moments are perpendicular to the z-axis; (5) only the σₓ, σ_{y} and τ_{xy} are significant, thus each xy-plane layer is biaxially stressed; (6) the Kirchhoff approximation, which is the idealization of the differential element retaining orthogonality when strained, applies; (7) the mid-thickness of the plate is a neutral plane, which is stress free; and for which the formulations are defined; and (8) deflection w is small (w/t <1/10) and d²w/dr²<<1, which is important for two reasons: (a) the loading pattern does not change as the beam deflects, and (b) the neutral layer remains stress free.

These piezoelectric actuators most significantly deviate from this simplified model in assumption (8). In this design, the ratio w/t of the deflection w to the disk thickness t can be equal to or greater than 1. The violation of this assumption implies that membrane theory is more applicable. Membrane theory uses a similar differential element model but additionally models the membrane as carrying the load in tension. Membrane theory is not well established, so it is preferably avoided. More important to the justification of plate theory is that assumption (8) is relevant to maintaining orthogonality between the differential elements and the applied load vector; which directly translates the load vector into axial shear. For this embodiment, the actuator disks are deflected with an internal strain, not an external load; which results in minimal static strain. When a load is applied, ratio w/t will be more on the order of 1/10. Additionally, the boundary condition does not induce a radial tension reaction force. For this embodiment, the global geometry is a circular disk, and the problem is most easily solved in cylindrical coordinates.

One of the advantages to this embodiment of the invention is the set of flexures on which the piezoelectric actuators rest. Conventional MEMS actuators have not used flexures. The flexure boundary conditions create a mathematic problem too complex for an analytical solution. A simpler argument is in comparing the fixed and simply supported boundary conditions on the deflections of a simple disk with uniform pressure loading. The actual load will cancel in the comparison, but the geometrical relationship of the load to the deflection is retained, and the case is similar to the uniform stress distribution due to the piezoelectric effect. The results of a calculation of ratio of the deflection W_{SimplySupported} supported with flexures to the deflection W_{fixed} of a disk having a fixed perimeter is indicated in Equation 1. Thus, a simply supported boundary condition gives a four-fold improvement on the stroke, a non-negligible advantage.

$$Equation 1 \text{:} \qquad \frac{{w}_{SimplySupported}}{{w}_{fixed}} = \frac{5 + v}{1 + v} \approx 4$$

The next issue is the required flexure length. One approach to identifying a suitable flexure length is to first derive the edge moment caused by a fixed edge boundary condition. Then, for this embodiment, assume that the flexure-induced moment M_{3FlexRxn} must be less than 1/10 of the fixed edge boundary condition moment M_{NetEdges} as indicated in Equation 2. This should be sufficient because the effect of the flexures is reduced since the flexures cover a fraction (e.g., about 1/18) of the actuator perimeter. Equation 3 gives the edge moment Mᵣ per unit length, and the net circumferential edge moment is given in Equation 4, where D is the flexural rigidity and assuming t=9.8 μm.

M_{NetEdge}>10M_{3FlexRxn} Equation 2

$$Equation 3 \text{:} \qquad {M}_{r} ( R ) = \frac{- 8 {E}_{PZT} w}{3 ( 1 - {v}^{2} )} \cdot \frac{{t}^{3}}{{D}^{2}}$$

M_{NetEdge}=5.9×10⁻⁶(Nm) Equation 4

This can now be evaluated versus the three support flexures' reaction moments. The flexures can be modeled as cantilever beams, whose reaction moments are obtained by applying a tip rotation due to the disk actuation. The Si₃N₄ layers, which are intentionally made thicker than the metal to prevent etch-through or electrical shorting, dominate since they have a combined thickness an order of magnitude greater than the combined metal, are on the outside of the flexure, and have a higher Young's modulus. A similar argument can be made for the RAINBOW. Thus, the model can be kept to a simple cantilever beam with a homogeneous cross section. The reaction moment from the three flexures is thus given in Equation 5.

$$Equation 5 \text{:} \qquad {M}_{3 FlexRxn} = \frac{- {E}_{Si3N4} {Wt}^{3}}{4 L} \cdot θ$$

The thickness has a cubic power effect; versus W and L, which only have a linear effect. With this in mind, logical values were chosen for dimensions of W and L of the flexure. Then, an upper boundary for t is derived. The design point is: M_{3FlexRxn}≦5.9×10⁻⁷ Nm; θ=0.0443 rad; W=50 μm; and L=20 μm. (10 μm is for actuator negative deflection, and another 10 μm for safe clearance at the maximum negative deflection.) This value for L could be increased if stiction proves to be a problem. These give a suitable total flexure thickness of about t<3.8 μm.

As described further below, the determined dimensions are for a PZT thickness of 9.8 μm. The Si₃N₄ is thinner than the PZT. Since the PZT and Si₃N₄ act as electrical insulators, the maximum voltage is now bounded by the Si₃N₄ dielectric strength E_{DS}. Thus, a maximum voltage Vₘₐₓ constraint is given in Equation 6, and this value is V_{max, flexure} is about 1900 V. Comparatively, the conservative maximum electric field E_{DS} is 2.5 MV/m for a thin PZT film. Therefore the PZT constrains the voltage to 62.5 V and 125 V, for the bimorph and RAINBOW, respectively. The flexures therefore do not constrain the operating voltage.

$$Equation 6 \text{:} \qquad {V}_{max , flexure} = {E}_{DS , Si3N4} \cdot \frac{t}{2}$$

The capability of a piezoelectric actuator is most strongly a function of the type of piezoelectric material and the type of configuration. Three popular types of piezoelectric material are ZnO, BaO, and Lead Zirconate Titanate (PZT). PZT can refer to a family of piezoelectric ceramics, such as: PZT, PLZT (lead lanthanum zirconate titanate), PBZT (lead barium zirconate titanate) and, more loosely, PMN (lead magnesium niobate). ZnO is the easiest to work with, but PZT has by far the highest piezoelectric response. Constant d₃₃ is typically 12 pC/N for ZnO and 500 pC/N for PZT, and there are a few derivatives of PZT that have an even higher response (e.g., PLZT, relaxor thin films). PZT has thus become the de facto choice for thick films (a sol-gel process). However, the thin film PZT processes such as CVD, sol-gel, and plasma sputtered PZT are only partially successful. Typically, the piezoelectric response is an order of magnitude less than in thick films. This also indicates that there is still much room for improvement in the thin film processes. These processes and their capabilities are described further below. Plasma sputtered PZT has been chosen for the exemplary embodiment of the invention since plasma sputtering of PZT is a conformal process and, in some cases, can be applied by the same tool that applies the metal layers.

Data characterizing the performance of a conventional bimorph having fixed boundaries is shown below. A bimorph that is circumferentially clamped is the standard commercially offered configuration, and Piezomechanick offers various disk bimorphs. For their CBM series (without centerbore) translators they claim the performance indicate in Table 1.

TABLE 1
Piezomechanick's CBM disk bimorphs.

| | | | | | | Resonant |
|---|---|---|---|---|---|---|
| | | | | Wₘₐₓ | F_{block} | Frequency |
| Type | D (mm) | t (mm) | E (KV/m) | (mm) | (N) | (KHz) |
| CBM | 15 | 0.6 | ±167 | ±10 | 3 | 20 |
| 100/15/010 M | | | | | | |
| CBM | 25 | 0.6 | ±167 | ±30 | 3 | 15 |
| 100/25/030 M | | | | | | |
| CBM | 35 | 0.6 | ±167 | ±70 | 3 | 6.5 |
| 100/35/070 M | | | | | | |

Piezomechanick's results are for disks that are circumferentially clamped 1 mm in from the edge. Thus, the actual diameter is 2 mm shorter, and the boundary condition is fixed. For the comparison, the diameters will be shortened by 2 mm, and the values of d₃₁=−280 pC/N (the best reported commercial value) and v=0.3 (standard value) are assumed.

Actuator speed can be a limiting factor for some types of actuators, for example, for the thermal actuators. However, piezoelectric vibrating tool ends are used in ultrasonic machining and speakers, whose operating frequencies are within the realm of 10 KHz, which is desired for a DM in a weapon system. However, the natural frequency also limits the actuator speed. If the actuator operates at frequencies at or above its first modal frequency, the device is in danger of catastrophic failure or a reduced MTBF. Equation 7 gives the natural frequency of a disk where E is the Young modulus, p is the density, t is thickness, D is diameter, and K is a constant having value 10.2 for a disk with fixed edges and 4.99 for a simply supported disk.

$$Equation 7 \text{:} \qquad {f}_{N} = \frac{2 K}{π} \sqrt{\frac{E}{3 ρ ( 1 - {v}^{2} )}} \cdot \frac{t}{{D}^{2}}$$

The slope of a plot of Equation 7 with the standard thick film parameters used herein, is 11000 Hz*m. This is 2.6 times the slope of 4205 Hz*m given in the Piezomechanick data. For the following analysis, Equation 8, which augments Equation 7 to include a corresponding empirical correction factor of 2.6, will be used.

$$Equation 8 \text{:} \qquad {f}_{N} = \frac{2 K}{2.6 π} \sqrt{\frac{E}{3 ρ ( 1 - {v}^{2} )}} \cdot \frac{t}{{D}^{2}}$$

All of the parameters except for thickness have been defined by higher design requirements, thus Equation 8 can be rearranged to find the ratio D²/t, which will be used in deflection formulas. Thus, this embodiment is bounded as indicated in Equation 8.

$$Equation 9 \text{:} \qquad \frac{{D}^{2}}{t} \leq \frac{2 K}{6.5 π {f}_{control}} \sqrt{\frac{E}{3 ρ ( 1 - {v}^{2} )}}$$

Based on Equation 9, the design point D²/t ratio is less than or equal to about 0.083 m. And, for a diameter D of about 0.9 mm, the thickness t of the piezoelectric is greater than about 9.8 μm.

The maximum deflection wₘₐₓ of a bimorph disk depends on the boundary conditions of the disk, constants υ and d₃₁ characterizing the piezoelectric properties of the disk, the maximum applied electric field E, the thickness t of the disk, and the diameter D of the disk. When the disk is simply supported (e.g., by flexures as described further below), a conservative derivation of the maximum deflection wₘₐₓ yields Equation 10. For a disk having boundary conditions corresponding to a fixed perimeter, the same calculation provides a deflection that is one quarter of the deflection for the simply supported configuration. The simply supported configuration thus provides a significant (i.e., a factor of four) improvement over the convention fixed boundary conditions. The conservative Equation 10 can be compared to measurements of piezoelectric actuators (e.g., such as the data in Table 1) to determine an empirical correction factor of about 19. Thus, an experimentally supported formula for the maximum deflection wₘₐₓ is given in Equation 11.

$$\begin{matrix}Equation 10 \text{:} & {w}_{max} = \frac{( 1 - v )}{4} \cdot {d}_{31} E \cdot \frac{{D}^{2}}{t} \\ Equation 11 \text{:} & {w}_{max} = 19 \frac{( 1 - v )}{4} \cdot {d}_{31} E \cdot \frac{{D}^{2}}{t}\end{matrix}$$

Another actuator property is the blocking force F_{block}, which is the amount of force required to prevent actuator deflection at a given applied electric field. Accordingly, blocking force F_{block}(E) for an electric field strength E is given by Hooke's Law as the product of the deflection w(E) and the stiffness k of the actuator. Equation 12 is a calculated value for the actuator stiffness in terms of the Young's modulus E and Poison ratio υ of the piezoelectric and the diameter D and thickness t of the disk. Based on the stiffness and deflection formulas, an empirically corrected formula for the blocking force F_{block} can be found.

$$Equation 12 \text{:} \qquad k = \frac{16 π {Et}^{3}}{3 ( 1 - v ) ( 3 + v ) {D}^{2}}$$

Another effect that can be accounted for in an actuator is stiction. Stiction can be loosely defined as the sum effect of molecular and atomic forces, such as Van der Waals and electrostatic forces. At the microscale these forces are significant. At the macro and mesoscales they are insignificant to engineering, which is why the fundamental materials engineering research on stiction is relatively immature. In terms of a peel number, Nₚ, the no stiction condition is Nₚ>1. This results in a restriction on the surface energy γₛ. The actuator disk will be slightly in tension due to the flexures. Tension increases Nₚ, thus reducing stiction effects. However, the flexures are designed to impart a negligible radial stress. Thus, with a conservative approximation that there is no radial stress, the restriction on the surface energy γₛ takes the form of Equation 13.

$$Equation 13 \text{:} \qquad {γ}_{s} < \frac{16 {Dh}^{2}}{{D}^{4}} [ 160 + \frac{252}{5} \cdot \frac{{h}^{2}}{{t}^{2}} ]$$

Among the configurations illustrated in FIGS. 4 and 5, a bimorph actuator is preferred. This following description emphasizes this embodiment, but various possible variants are also presented to show their relative strengths and weaknesses. For the preferred embodiment of a bimorph with a Si₃N₄ mirror, an actuator thickness of 50 μm defines a design point with balanced margins. Equations 14 provide a summary of the dimensions and operational parameters of an exemplary embodiment.

t_{actuator}=50 μm

$${γ}_{s} < 1145000 \frac{m J}{{m}^{2}}$$

t_{flexure}≦20 μm

wₘₐₓ<12.5 μm

$${k}_{actuator} = 68.3 \frac{K N}{m}$$

F_{block}=683 mN: For a deflection of 10 μm.

tₘᵢᵣᵣₒᵣ=15 μm Equation 14

Manufacturing Processes

The following describes some exemplary manufacturing processes in accordance with exemplary embodiments of the invention. The disclosed processes allow manufacture of different actuator types for use in a deformable mirror or other systems.

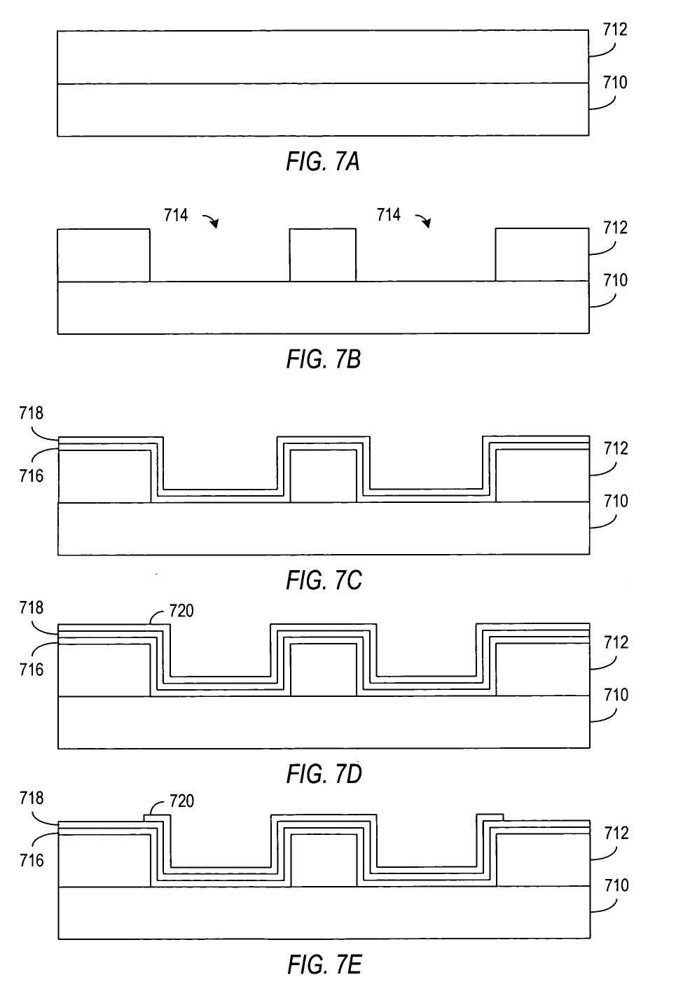

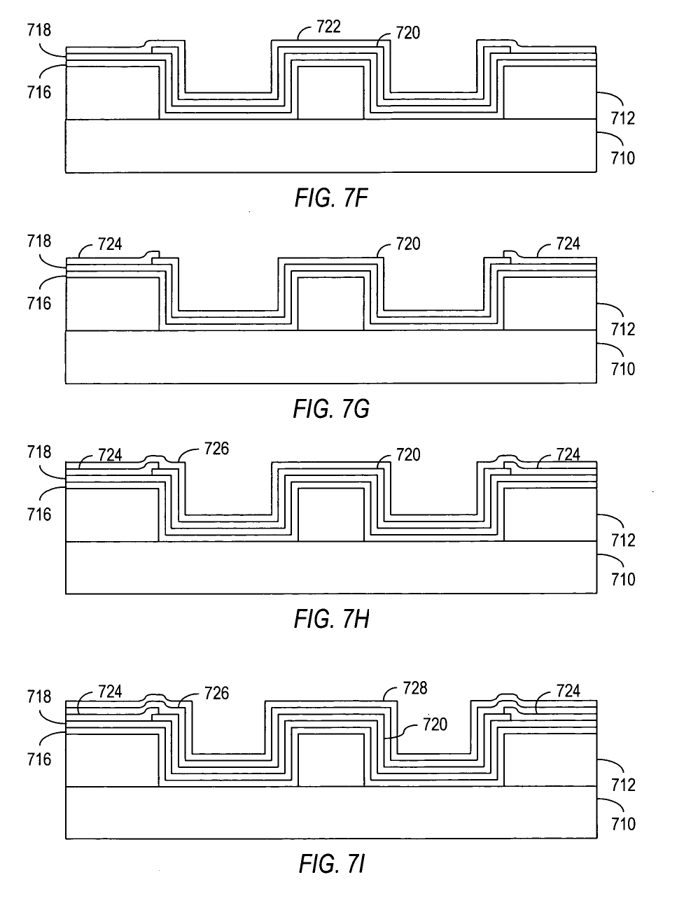

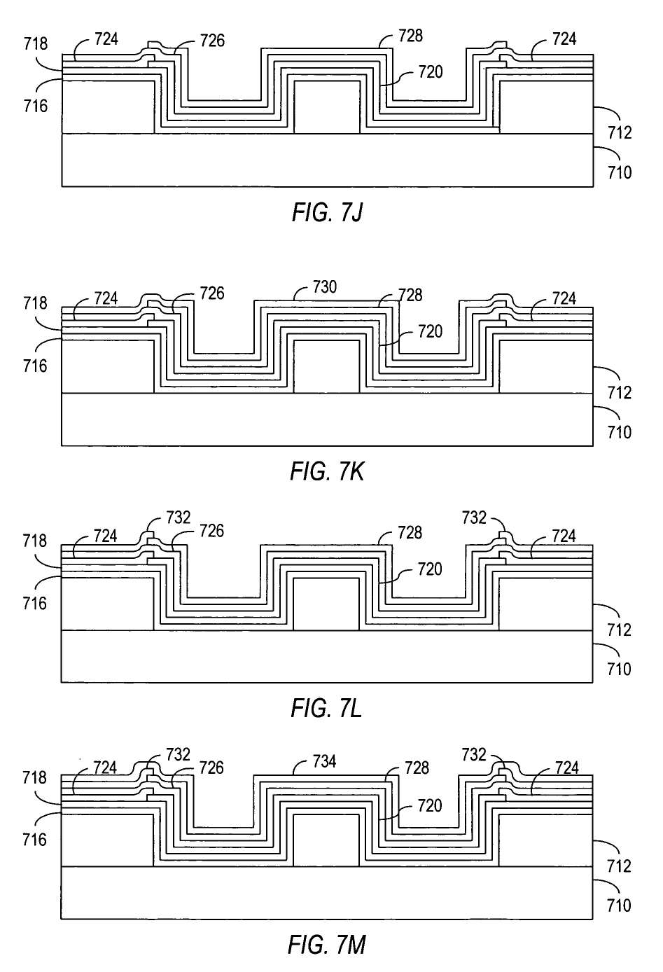

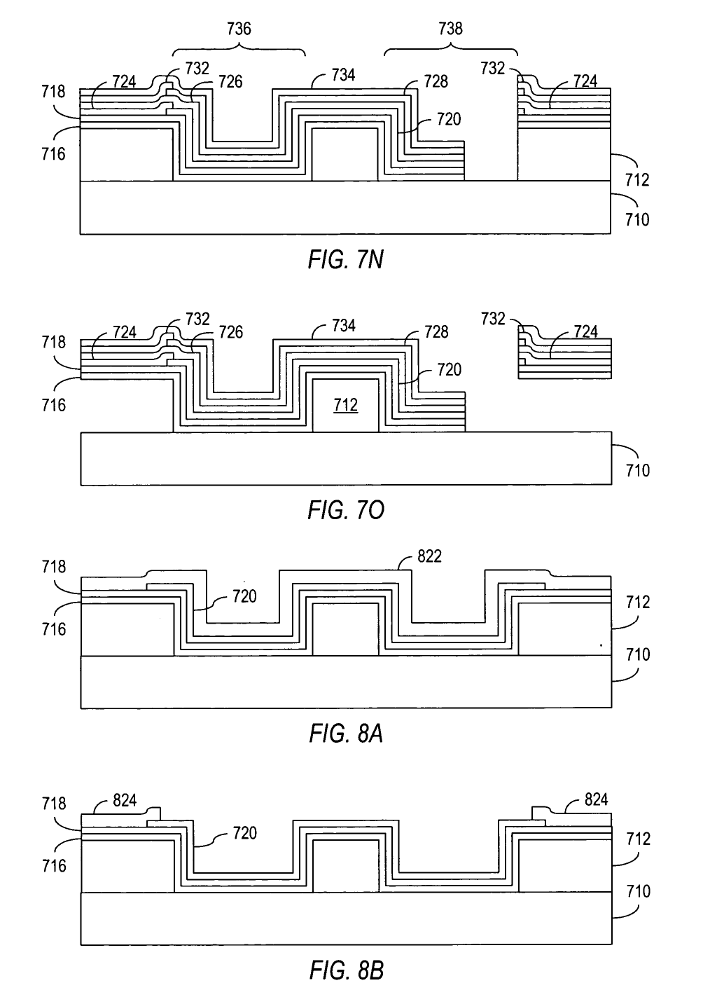

FIGS. 7A to 7O illustrate cross-sectional views of structures formed during the process for manufacture of a bimorph actuator array including a sputtered PZT layer. Specific techniques for performing the illustrated steps are described further below in a section on material properties and processes. The portion of an actuator array illustrated in FIGS. 7A to 7O corresponds to edges of two actuators with a flexure near the center of the drawings. Each actuator generally includes a set of three or more flexures that are distributed about the perimeter of the actuator.

FIG. 7A shows a portion of an initial structure including a wafer 710 on which a sacrificial layer 712 is formed. Wafer 710 is preferably a silicon nitride (Si₃N₄) wafer or a conventional silicon wafer that is treated to form a silicon nitride layer. Sacrificial layer 712 is preferably a glass (e.g., a PSG) layer that is about 20 μm thick.

Sacrificial layer 712 is patterned to form openings or trenches 714 that expose portions of wafer 710 and extend around areas corresponding to the actuators being fabricated. A conventional photolithography and etching process, for example, using a wet etch can form trench 714. Typically, such processes includes spinning a photoresist layer (not shown) onto sacrificial layer 712, exposing the photoresist using a first mask, developing the photoresist to expose selected areas of sacrificial layer 712, and etching portions of sacrificial layer 712 that the photoresist exposes.

A silicon nitride layer 716 and then a metal layer 718 are formed on the surface of glass layer 712 and in trenches 714 as shown in FIG. 7C. Metal layer 718 is preferable a combination of a titanium layer that is on silicon nitride layer 716 and a platinum layer that is on the titanium layer, and layer 718 preferably has a total thickness of about 280 μm. After deposition of layers 716 and 718, the structure of FIG. 7C can be annealed, for example, at a temperature of 650° C. for 30 s to reduce shear stresses in the structure. A conventional photolithography process with wet or dry etching can then be used to pattern metal layer 718 as required to form bottom electrodes on sacrificial layer 712 and traces in trenches 714. Silicon nitride layer 716 can be etched using the same mask as used for metal layer 718, so that each region of sacrificial layer 712 that is under a bottom electrode will be exposed around most of its perimeter in trench 714.

Plasma sputtering or any other suitable deposition process forms a silicon nitride or other insulating layer 720 on the patterned metal layer 718 as shown in FIG. 7D. Silicon nitride layer 720 is then patterned as shown in FIG. 7E to expose metal layer 718 in the areas where metal layer 718 forms the bottom electrodes of the actuators. Silicon nitride layer 720 remains on metal layer 718 in the areas of the flexures of the actuators.

FIG. 7F shows the structure after deposition of a PZT layer 722. In an exemplary embodiment of the invention, plasma sputtering deposits PZT layer 722 with a thickness of about 1 to 25 μm, but other techniques such as described below can alternatively be used. A conventional photolithography process can then pattern PZT layer 722 to form PZT disks 724 for the actuators as shown in FIG. 7G.

A metal layer 726, which preferably contains platinum about 100 nm thick, is deposited on the structure as shown in FIG. 7H. The structure including metal layer 726 can then be anneal, e.g., at about 650° C. for 30 seconds, before metal layer 726 is patterned using convention photolithography and etching. This masking and etching removes metal layer 726 to provide clearance for vias to metal layer 718, but leaves metal layer 716 where required for middle electrodes in the bimorph actuators or for traces (e.g., in the flexure) for electrical connections to the middle electrodes.

An insulating layer 728, preferably of silicon nitride about 0.2 μm thick, is deposited on the structure as shown in FIG. 71. As shown in FIG. 7J, photolithography and etching removes silicon nitride layer 728 from the areas of the actuator disks in the actuator array.

A second PZT layer 730 is deposited on the structure as shown in FIG. 7K, and patterned to form actuator disks 732 as shown in FIG. 7L. PZT layer 730 and PZT disks 732 can be formed using the same processes and parameters as used for PZT layer 722 and disks 724. At this point vias or openings can be etched where required for electrical contacts to the middle electrodes (i.e., to layer 726). Vias can also be also be etched for electrical contacts to the bottom electrodes (i.e., to layer 718). FIG. 7M shows the structure after deposition of a third metal/platinum layer 734, which forms the top electrodes of the bimorph actuators.

An etch process such as a reactive ion etch (RIE) then etches through selected areas of layers 716 to 734 around the circumference of the actuator disks, except in areas corresponding to the flexures. FIG. 7N shows an area 736 of a flexure for a first actuator and an area 738 where the perimeter of a second actuator will be unsupported. As noted above, each actuator may have a number (e.g., three) flexure while being elsewhere unsupported.

The etching around the perimeter of the actuators exposes sacrificial layer 712 underlying the areas of the actuators. A selective etching process such as a vapor etch using buffered hydrofluoric acid can remove sacrificial layer 712 from under the actuators, while leaving the rest of the structure intact as shown in FIG. 7O.

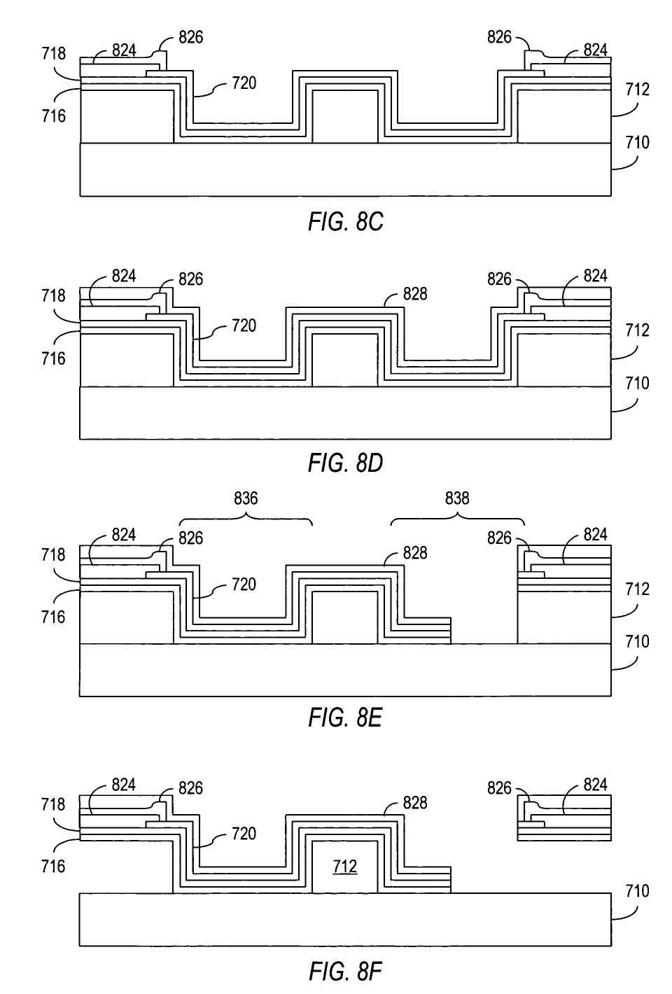

FIGS. 8A to 8F illustrate cross-sectional views of structures formed during the process for forming an array of RAINBOW actuators. Specific techniques for performing the steps in the process of FIGS. 8A to 8F are described further below in a section on material properties and processes.

FIG. 8A illustrates a stage in the process after deposition of a PZT layer 822 on an underlying structure including a wafer 710, a sacrificial layer 712, a silicon nitride layer 716, a metal layer 718, and a silicon nitride layer 720. The properties and fabrication process for these underlying structures can be the same as those described above in regards to FIGS. 7A to 7E. PZT layer 822 of FIG. 8A is substantially the same as PZT layer 722 of FIG. 7F except that PZT layer 822 may be thicker than PZT layer 722. In an exemplary embodiment of the invention, PZT layer 822 is about 1 to 25 μm thick.

PZT layer 822 is etched as shown in FIG. 8B to form disks 824 for the actuators in the array being formed. To form RAINBOW actuators, the top surfaces of disks 824 are reduced. The reduction process can be conducted in a furnace that keeps the structure at an elevated temperature in the presence of a gas such as hydrogen. As illustrated in FIG. 8C, a reduced layer 826 is thus formed on a remainder of PZT disks 824.

Following the reduction process, a platinum or other metal layer 828 is deposited as shown in FIG. 8D, and the structure is annealed to relieve stress. Metal layer 828 can then be patterned to form the top electrodes, traces for electrical connections, and to provide clearance for vias to metal layer 718.

Layers 716 to 828 are removed by etching around the perimeters of the actuators, except in areas where flexures reside. FIG. 8E includes an area 836 corresponding to a flexure of a first actuator and an area 838 corresponding to an unsupported portion of the perimeter of a second actuator. This etching exposes portions of sacrificial layer 712 permitting a selective etching process to remove sacrificial layer 712 from under the RAINBOW actuators.

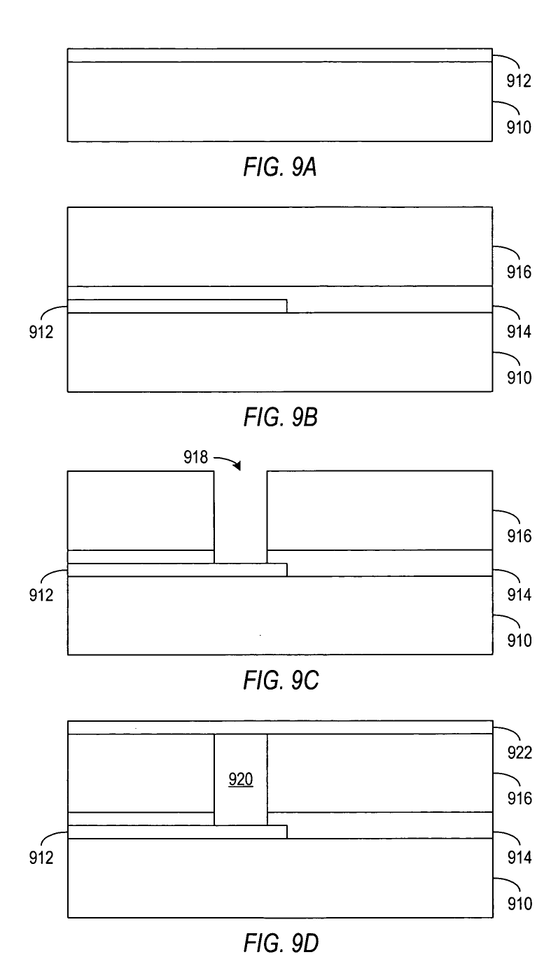

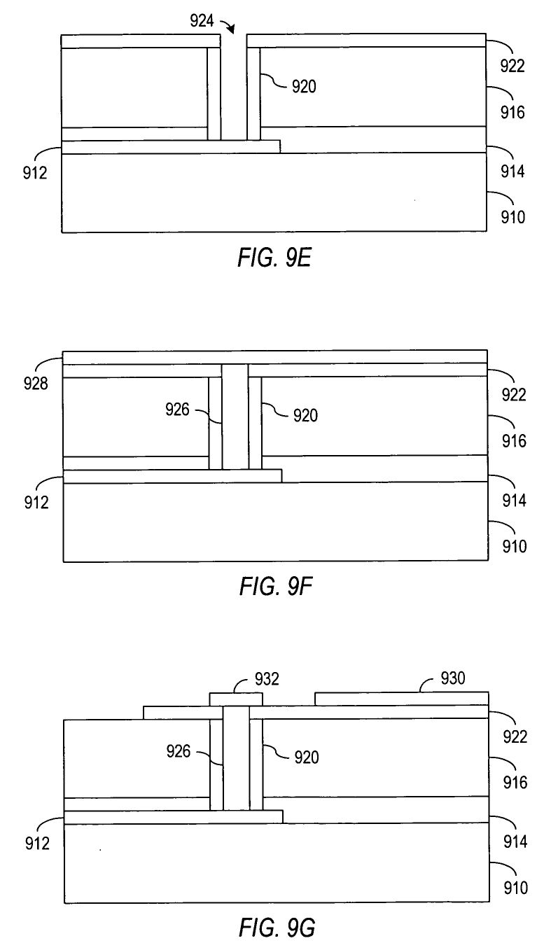

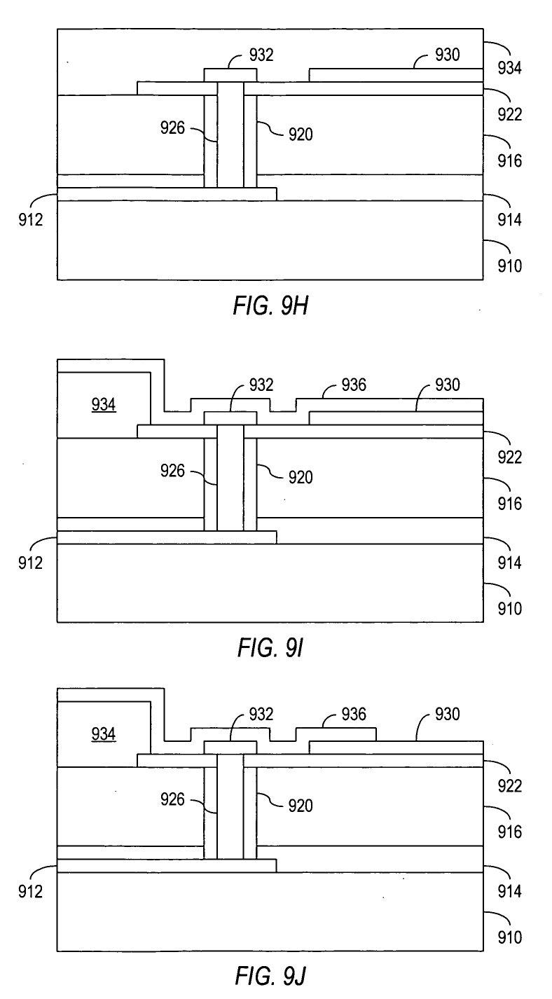

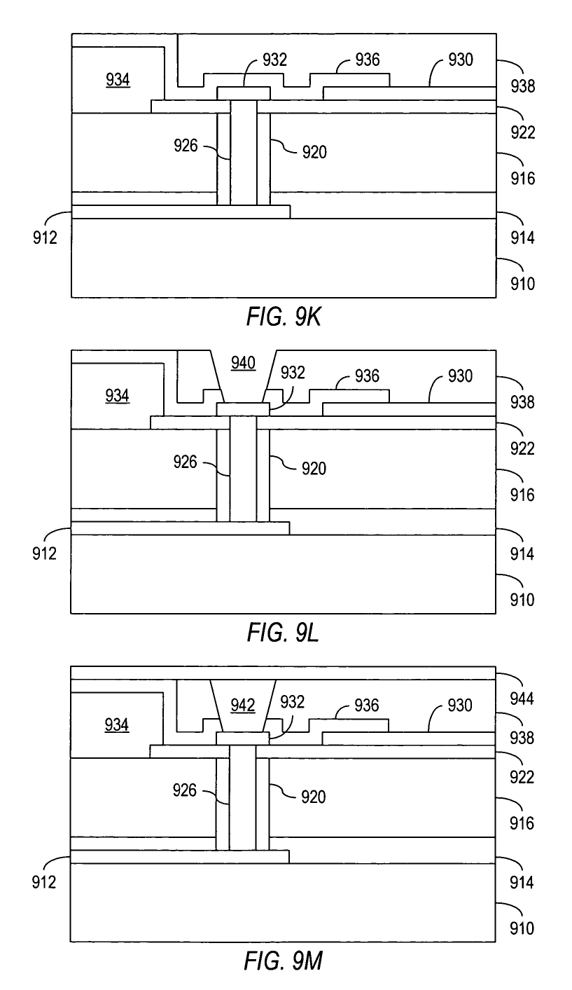

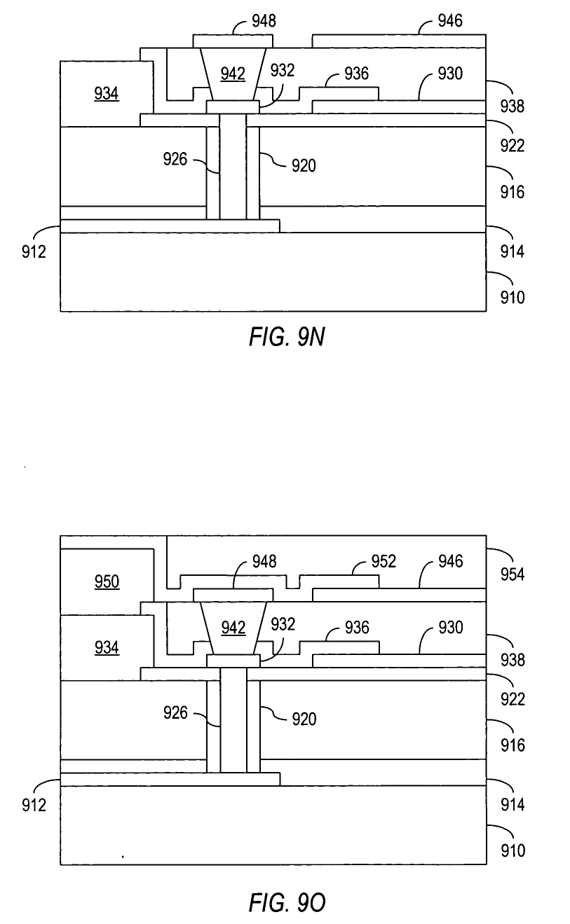

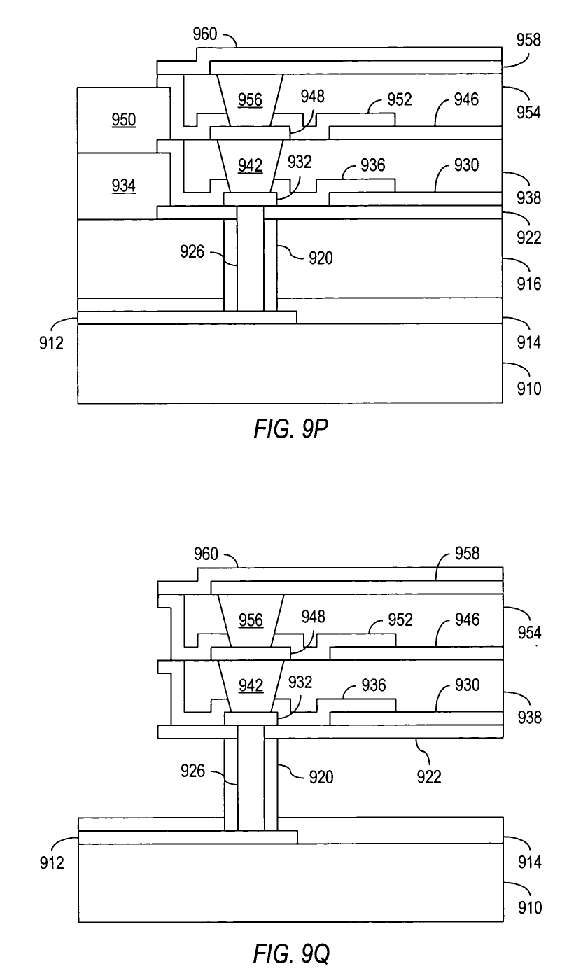

FIGS. 9A to 9Q illustrate another process for fabrication of a bimorph actuator or an array of bimorph actuators. FIGS. 9A to 9Q concentrate on a portion of an actuator or actuator array including a via that provides an electrical connection to a top electrode. Vias providing electrical connections to bottom or middle electrodes as similar in structure but with differences noted further below. This process is lengthier than the above processes but is based on well-established wafer processing techniques. In particular, the process allows either sol-gel or RF magnetron sputtering for formation of PZT layers. In addition, several processes described below, e.g., many of the chemical mechanical polishing (CMP) steps, are not critical or could be avoided with tight process controls.

FIG. 9A illustrates the start of the manufacturing process with a wafer 910 that is preferably either a Si₃N₄ wafer or a silicon wafer having a top surface coated with Si₃N₄ that can be formed by doping wafer 910 with nitrogen or by depositing a layer (not shown) of Si₃N₄. A trace layer 912 of a metal such as aluminum or other conductive material is deposited on wafer 910, for example, by evaporative deposition.

As shown in FIG. 9B, trace layer 912 is patterned to form conductive traces used for electrical connections to the bimorphs actuators being formed. Well-known photolithographic processes (e.g., that spin on photoresist, expose to the photoresist using a trace mask, and then develop the photoresist) and etching process such as a wet etch can form the desired trace pattern. A cleaning or de-sum process can follow the etch process. More generally, additional trace layers can be added if required for a large array of actuators. Plasma enhanced chemical vapor deposition (PECVD) or another suitable process can then form a Si₃N₄ protective layer 914 on traces 912 and exposed portions of wafer 910. A sacrificial layer 916 of a material such as a spin on glass (SOG) and preferably a phosphosilicate glass (PSG) that about 20 μm thick is deposited on silicon nitride layer 914.

FIG. 9C shows the structure after an etch process forms trenches or openings 918 through glass layer 916 and nitride layer 914 to expose a portion trace layer 912. A DRIE process followed by a cleaning or de-scum process can be used to form openings 918. As described further below, each opening 918 corresponds to the location of a flexure that supports a portion of the perimeter of an actuator and that provides electrical connection of a trace layer 912 to one of the electrodes of the actuators.

A PECVD process or other suitable process fills openings 918 with silicon nitride as shown in FIG. 9D. Chemical mechanical polishing (CMP) can be used after filling openings 918 to planarize the structure and expose sacrificial layer 916. PECVD or another suitable process then forms a silicon nitride layer 922 on the surface of the structure. As described further below, silicon nitride layer 922 protects the bottom electrodes of the actuators during removal of portions of sacrificial layer 916.

A masked etch process such as DRIE forms trenches or opening 924 through the structure down to trace layer 912 as shown in FIG. 9E. Openings 924 are in substantially the same location as openings 918 of FIG. 9C but are smaller so that a portion of silicon nitride 920 remains on the sidewalls of openings 924. Silicon nitride 920 on the sidewalls of openings 924 is preferably thicker than about 0.5 μm to protect metal plugs during removal of portions of sacrificial layer 916 and to provide desired structural properties. The resulting structure can be cleaned or de-scummed after the etch process.

As shown in FIG. 9F, an electroplating process can fill openings 924 with a metal plug 926 of aluminum or other suitable conductive material. CMP can then be used if necessary to planarize the structure before deposition of a bottom electrode layer 928. In a preferred embodiment, bottom electrode layer 928 includes a titanium layer deposited on plug 926 and nitride layer 922 and a platinum layer deposited on the titanium layer. The structure can be annealed after deposition of platinum.

A conventional masked etch patterns electrode layer 928 as shown in FIG. 9G to form bottom electrodes 930 of the actuators, contact pads 932 on plugs 926, and traces electrically connecting selected contact pads 932 to bottom electrodes 930. In an exemplary, embodiment of the invention, each bimorph actuator has three flexures that are spaced apart at 120° intervals around the perimeter of the actuator, and one out of the three flexures provides an electrical connection to the bottom electrode 930 of the actuator. The other two flexures provide electrical connections to the middle and top electrodes, respectively. In FIG. 9G, plug 926 and surrounding nitride 920 corresponds to a flexure that is not connected to bottom electrode 930. Accordingly, FIG. 9G does not show a trace connecting contact pad 932 to electrode 930.

After patterning of electrode layer 928, a masked etch process patterns silicon nitride layer 922 to leave silicon nitride layer 922 under bottom electrodes 920 and contact pads 932 but to expose sacrificial layer 916 elsewhere. A cleaning or de-scum process can clean the structure after that etching of electrode layer 928 and silicon nitride layer 922.

A sacrificial layer 934 is deposited on the structure as shown in FIG. 9H. Sacrificial layer 934 is preferably made of the same material as sacrificial layer 916 and in an exemplary embodiment of the invention is a glass layer about 1 to 25 μm thick, depending on the desired thickness of the bottom PZT layer. A DRIE or similar etch process removes the portions of sacrificial layer 934 as shown in FIG. 91 to form mold areas for PZT disks of the actuators. This etching process should be controlled to avoid etching through Si₃N₄ layer 922. The structure can be cleaned or de-scummed after the etch process and before a deposition process such as PECVD forms a Si₃N₄ layer 936 on the bottom and sidewalls of the mold area.

FIG. 9J shows the structure after removal of portions of Si₃N₄ layer 936 from central areas of bottom electrode 930. The topology of the structure can make it difficult to use a photoresist mask in this etching process. Accordingly, an etch process such as RIE using a metal mask with pinhole apertures can be used. A benefit of removing these portions of layer 936 is the reduction of counteracting stresses that oppose expansion and dishing of PZT layers. However, this patterning of silicon layer 936 is a non-critical feature and can be omitted to simplify the fabrication process.

FIG. 9K shows the structure after formation of a PZT layer 938 and planarization of the PZT layer to the level of Si₃N₄ layer 936 on top of sacrificial layer 934. RF magnetron sputtering or a sol-gel squeegee process can form PZT layer 938 on bottom electrodes 930 in the mold area created by patterning sacrificial layer 934. CMP can then planarize PZT layer 938 at the level of Si₃N₄ layer 936.

A conventional photolithographic and etching process (e.g., DRIE) forms openings or vias 940 through PZT layer 938 and silicon nitride layer 936 over selected contact pads 932 as shown in FIG. 9L. Vias 940 are for electrical connections to the middle or upper electrodes to be formed above PZT layer 938. In an exemplary embodiment of the invention including a bimorph actuator with three flexures as described above, one flexure of each actuator provides electrical connection to the bottom electrode, and via 940 is not required for that flexure. The other two flexures respectively provide connections to the middle and top electrode of the bimorph actuator. FIG. 9L shows structure corresponding to a flexure electrically connected to the top electrode and therefore includes via 940.

Electroplating of aluminum out from platinum contact pad 932 forms a plug 942 in via 940 as shown in FIG. 9M. CMP can planarize the structure if necessary before deposition of a middle electrode layer 944. In an exemplary embodiment of the invention, electrode layer 944 includes platinum layer on PZT layer 938 and a titanium layer on the platinum layer. This order ensures that PZT layer 938 has at least one side against a platinum catalyst. The structure can be annealed after formation of electrode layer 944.

As shown in FIG. 9N, a masked etch process such as a wet etch patterns middle electrode layer 944 to form middle electrodes 946, contact pads 948, and traces (not shown) connecting selected contact pads 946 to associated middle electrodes 946. Silicon nitride layer 922 is then etched where required to expose portions of sacrificial layer 934. A cleaning process can be performed between or after the etch processes.

A second PZT layer 954 shown in FIG. 9O is formed in substantially the same manner as the first PZT layer 938. In particular, a sacrificial layer 950 of a spin on glass PSG is deposited and patterned to form mold areas for PZT layer 954. The mask for etching layer 950 can be almost identical to the mask for layer 934, except that the outer perimeter of the mold area may be slightly farther out to ensure good overlap of the Si₃N₄ wall layers. A silicon nitride layer 952 is then formed on sacrificial layer 950, contact pads 948, and middle electrodes 946 before an etch process removes silicon nitride layer 952 from over the central portions of middle electrodes 946. RF magnetron sputtering or a sol-gel squeegee process can the form PZT layer 954, before a CMP process planarizes the structure to the level of silicon nitride layer 952.

DRIE or similar patterned etch process forms vias through PZT layer 954 and silicon nitride layer 952 over the flexures that provide electrical connections to top electrodes of the bimorph actuators. The vias are filed with a conductive plug 956 as shown in FIG. 9P. Conductive plug 956 can be formed, for example, by electroplating aluminum onto contact pad 948 and then using CMP if necessary to planarize the resulting structure. A top electrode layer 958 is formed, preferably containing platinum, and patterned to form the top electrodes and electrical connections to selected flexures through plugs 956. In an exemplary embodiment of the invention, top electrode layer 958 includes a platinum layer on PZT layer 954 and a titanium layer on the platinum layer.

A silicon nitride layer 960 can be formed on the top electrode layer 958 to protect and insulate the top electrodes. A conventional patterned etching process then removes portions of silicon nitride layers 960 and 952 to expose portions of sacrificial layer 950.

A selective wet etch or vapor etch removes sacrificial layers 950, 934, and 916, leaving the structure of FIG. 9Q. Removal of sacrificial layer 916 under the bimorph actuators permits dishing of PZT disks 938 and 954 when appropriate voltages are applied to electrodes 930, 946, and 958 through the flexures. Nitride layers 960, 952, 936, 922, and 920, which protect the structure during the etch process that removes the sacrificial layers, continues to provide protection from the surrounding environment. One of the last steps in the process is to back etch wafer 910 to form openings (not shown) through wafer 910. The creation of such openings can improve or simplify the process of removing sacrificial material under the actuators. Additionally, a micro-pump can use such openings for flow of coolant, e.g., a liquid metal coolant, which may be required for the high-energy laser DM actuator.

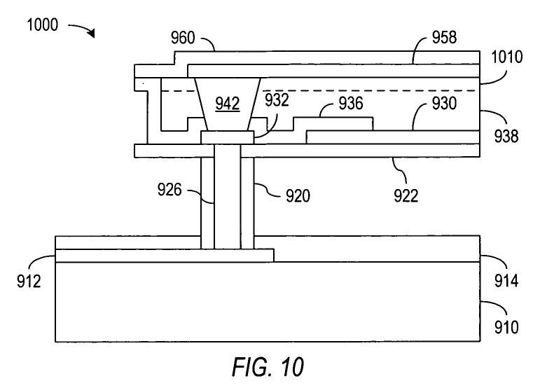

A process similar to the process of FIGS. 9A to 9Q, which creates an array of bimorph actuators, can create one or an array of RAINBOW actuators. FIG. 10 shows a cross-section of a portion of a completed RAINBOW actuator 1000. RAINBOW actuator 1000 includes a substrate 910, conductive traces 912, protective layers 914, 920, 922 and 936, conductive plug 920, contact pad 932, bottom electrode 930, and PZT layer 938, which can be fabricated using the techniques described above in regards to FIGS. 9A to 9K. For the RAINBOW actuator, the top of PZT layer 938 is reduced to form a layer 1010 having different piezoelectric properties. RAINBOW actuator 1000 does not require a middle electrode or an upper PZT layer. Instead, conductive plugs 942 are formed through reduced layer 1010, PZT layer 938, and protective layer 936 at the flexures that provide electrical connections to a top electrode 958 formed on reduced layer 1010. To complete RAINBOW actuator 1000, a protective cap layer 960 is deposited on top electrode 958, and the sacrificial layers (not shown) are removed in the same manner as described above.

The above actuator array formation processes can be augmented to form deformable mirrors. For this, mirror membrane processes can be added to the above process, for example, just before or just after removal of the sacrificial material frees the actuators for operation.

Approaches to building a mirror membrane onto an actuator array include surface machining and surface attachment. Surface machining can employ a sacrificial layer on which the membrane is deposited. The key problem with this approach is the etch removal of this sacrificial layer. Since the mirror membrane is continuous, the etch length is the radius of the DM, which is a very large distance in micromachining. Thus, the etchant may adversely etch structural layers. One way to circumvent this problem with etchant vias in the membrane. This is acceptable for lower irradiance DMs, but not for laser weapons. MEMS can alternatively be manufactured by bonding two or more thin film subassemblies (e.g., Redwood Microsystems' micropumps). A form of this approach is preferable for manufacturing the high irradiance DMs.

An indium mirror membrane could become standard on the communications system because pure indium has one of the lowest Young's modulii of all elements. This increases the gain margin of the actuator since an indium mirror membrane has a low spring reaction force. Indium also excels due to its very low melting point, which permits sputtering at relatively low temperatures. This enables either sputtering directly onto a developed photoresist or a sacrificial polymer layer, which etching can remove with negligible structural damage. Finally, there are no additional treatments required for reflectivity because Indium's reflectivity curve is very similar to silver (and silver is the typical reflective coating for imaging optics). Indium has an advantage over silver, in that indium does not oxidize in the same manner as silver. Despite all of these advantages, indium's low melting point may make indium unsuited for a high irradiance DM.

Silicon nitride (Si₃N₄) is one of the best performing materials for precision engineering and optomechanical engineering. SiC has a slight material properties advantage, but Si₃N₄ thin film processes are more developed. The cardinal advantage of Si₃N₄ and other Ceramic, Glass, and Single Crystal (CGSC) materials are their thermal properties. For the high irradiance DM, not only should the DM not be thermally damaged, but also it should have a negligible thermal response. Si₃N₄ has excellent thermal properties. However, Si₃N₄ has poor optical properties, and a high irradiance DM using a Si₃N₄ mirror membrane will require high reflectance dielectric coatings. The dielectric coatings create another problem, differential stress warping because the Si₃N₄ and optical coating generally have different coefficients of thermal expansion. Since HR coatings are sputtered onto the Si₃N₄ at an elevated temperature (i.e., 300° C.), the membrane warps when it cools down to the atmospheric operational temperature. The most direct means of correcting the gross effect of warping is to apply an equivalent dielectric coating on the “back” side of the Si₃N₄. The backside coating can balance most of the stress differential.

For a continuous membrane that is not sputtered onto a polymer, formation of the mirror membrane can employ a bonding technique. One of the concerns with this technique is that both bond surfaces should be optically flat. The best way of accomplishing this is to first surface machine piston rods onto the centers of the actuator disks, which enables this assembly half to be optically finished. The mirror membrane can the be on an optically flat glass plate and could then be bonded to the piston rod ends, for example, using optical adhesive, solder, or fusion bonding (or “optical contacting”). Optical adhesives and solders generally have large coefficient of thermal expansion and low melting point so they are a poor choice. Fusion bonding is thus preferred, but generally requires that the two bonding surfaces be within the same material family.

Cooling of the mirror membrane can be accomplished through flow of a liquid coolant through the vacant space around and under the actuators and mirror membrane. A liquid metal such as mercury or indium is preferred for DM in high-energy applications. The flow of the coolant can be driven by micro-pumps to create laminar flow along the substrate under the actuator array, and openings can be back etched through the substrate to provide inlets and outlets for the coolant flow.

Material Properties and Processes

Tables 2 and 3 indicate relevant material properties and material process properties for manufacture of piezoelectric actuators and deformable mirrors in accordance with exemplary embodiments of the invention. The stated PZT values are typically values of traditional sol-gel PZT, unless otherwise stated. As with all material properties data, there is a range of measured values.

TABLE 2
Material Mechanical Properties

| | | | | σ_{y}, | σᵤ, |
|---|---|---|---|---|---|
| | E, Young's | ν, | ρ, | Yield | Ultimate |
| | Modulus | Poisson | Density | Stress | Stress |
| Material | (GPa) | ratio | (10³ Kg/m³) | (GPa) | (GPa) |
| PZT | 61 | 0.3 | 7.8 | | |
| Reduced | 28.8 | | 7.9 | | |
| PZT | (34 original | | | | |
| | PZT) | | | | |
| Si₃N₄ | 270-385 | 0.27 | 2.9-3.2 | 14 | |
| (LPCVD) | | | | | |
| SiO₂ | 73 | 0.2 | 2.3 | 8.4 | |
| Si | 129.5-186.5 | 0.23 | 2.3 | 7.0 | |
| In | 10.6 | 0.45 | 7.3 | | |

TABLE 3
Material Processing Deposition Properties

| Mate- | | | |
|---|---|---|---|
| rial | Function | Deposition | Anneal |
| PZT | Actuating | Plasma: | Per Plasma: RTA @ |
| | material | 100 nm/hr. | 650° C. for 30 s. |
| | | | The range of 500° C. |
| | | | to 700° C. is necessary |
| | | | for perovskite nucle- |
| | | | ating. O₂ atmosphere |
| | | | creates a best response |
| | | | curve, but N₂ or Ar |
| | | | creates lowest |
| | | | residual stress. |
| Si₃N₄ | Low stress | | |
| | substrate | | |
| SiO₂ | Si₃N₄ to Ti | Phosphorous | Anneal @ 450° C. |
| | adhesive | Silicon Glass | |
| | and sacri- | (PSG) @ | |
| | ficial | 450° C. | |
| | material. | | |
| Ti | Si—Pt barrier | See below. | TiO₂ seed layer |
| | and TiO₂ | | requires |
| | enhances the | | tₐₙₙₑₐₗ > 20 min. |
| | Pt <111> | | |
| | crystal lattice. | | |
| Pt | PZT <111> | Pwr = 200 W | SiO₂/Ti/Pt RTA @ |
| | crystal lattice | t = 5 min | 650° C. for 30 s. |
| | catalyst. | Atm = 95 | Done at UCB with |
| | | sccm Ar. | Heatpulse 210T RTA. |
| | | Substrate | A 400 to 500° C. |
| | | not heated. | anneal decreases |
| | | Ti/Pt Dep | Ti—Pt strain. |
| | | done in | This is believed to |
| | | Perkin Elmer | be due to <200> |
| | | 2400 Randex. | oriented Pt grains. |

One of the most challenging processes in actuator or DM fabrication is the removal of the sacrificial materials such as glass or SiO₂. HF etches most materials, but at different rates. Thus, the removal process must carefully encompass features to minimize this final etch on all materials, and preferably increase the etch rate of the SiO₂. The SiO₂ etch rate can be increased via geometrical means, essentially increasing the surface area of the sacrificial SiO₂. Conversely, features can protect the SiO₂ required for adhesion. In addition, oxides in general have high HF etch rates. PZT is an oxide, thus the Si₃N₄ barrier layers can be included to protect the PZT from the final HF etch. The last key material of concern is the titanium. Titanium is generally a relatively thin layer—preferably less than 100 nm in the axial direction—and yet the titanium will have a large surface area normal to axial direction and may be exposed to the HF for a relatively long time. The relative etch rate ratios between SiO₂ and titanium are 2.76:1 and 1900:1 for wet and vapor etching, respectively. Clearly vapor etching provides a far better differential etch rate than wet etching.

Thus, for the sacrificial SiO₂ etch in the radial direction (450 pm), there is a commensurate Ti etch of 240 nm. There are three main concerns: (1) minimal undercutting at Ti/substrate interface so that the SiO₂ adhesion is not compromised, (2) minimal loss at the disk edges so that the PZT is not compromised and (3) the electrodes cross-section is not so small as to create an unacceptable electrical resistance. For path length of at least 10 μm between the sacrificial layer and the adhesion layer, (1) is not a concern. The Si₃N₄ ring width will be 1 μm or greater to eliminate concern (2). The greatest danger of (3) is at the flexures. Electrical contact could be lost. This requires that the combined thickness of the first Pt/Ti layer be greater than 240 nm, plus an additional thickness for process deviations. A sum of the deposition rate and etch rate deviations is roughly 15%, thus the combined Pt/Ti bottom electrode layers should be 280 nm where exposed to etching. The bottom electrode thickness as a function of radius will be roughly a linear slope from 40 nm at the outer edge, to 280 nm at the center. A design objective is to minimize the electrode thicknesses. A thickness of 280 nm is relatively large compared to the PZT thickness. A possible means is the use of etch-vias in the actuator disks or multiple titanium depositions to create a stepped radial thickness. Etching vias could potentially lower the sacrificial SiO₂ etch length to 150 μm, with a commensurate 80 nm of Ti etch. Similarly, the top Pt electrode must be protected during the final HF etch, thus the PR from the flexures etch will be removed after the final HF etch.

PZT thin film processing, especially deposition, is an immature process at this time. There is a substantial effort to improve these processes to the point at which they, at a minimum, obtain the same piezoelectric properties as traditional sol-gel processing. The following is a summary of some processes currently being used.

The typical form of PZT devise manufacturing uses sol-gel techniques to make thick film devices. Sol-gel can also be used for relatively thin films. Three characteristics of thin film deposition (relative to thick film (bulk) manufacturing) are: 1.) high coercive fields ( [symbol] _{DP}): 5 Mv/m to 10 MV/m; 2.) high breakdown voltages ( [symbol] _{DS}): 20 MV/m to 40 MV/m; and 3.) low piezoelectric coefficients (d₃₃=50 to 100). Of these, 1.) and 2.) offer an improvement, but 3.) could be improved to at least the thick film sol-gel values, which currently are almost ten times better. What distinguishes the three common techniques are their end surface type and the piezoelectric effectiveness. Sol-gel creates a planar top surface, sputtering creates a match of the underlying surface topology, and CVD creates something in between these two. For the exemplary embodiment, an underlying surface match is preferred, which favors sputtering. But, sputtering is currently an order of magnitude less effective then sol-gel in piezoelectric effect quality. Additionally, sol-gel or metal oxide chemical vapor deposition (MOCVD) could conceivably be used. They would require a few more dry etch steps; which is why they are not preferred.

The perovskite percentage in PZT is related to the processing temperatures of the four different deposition processes. To obtain near 100% perovskite, the following process temperatures are required: 600° C. to 650° C. for plasma vapor deposition (PVD), 500° C. to 550° C. for PLD (Pulsed Laser Deposition); 650° C. to 700° C. accomplished during the post-anneal for CSD (sol-gel); and 690° C. to 700° C. for MOCVD. Thus, the preferred process (PVD) has a reasonable temperature relative to the other processes.

PZT is typically grown on platinum (Pt) for the following three reasons. First, PZT cannot be deposited directly onto a silicon-based substrate due to diffusion and oxidation that occurs between PZT and silicon. Second, the PZT in actuators needs to be surrounded by conductive electrodes. And third, an underlying (111) lattice acts as a catalyst to the growth of a perovskite (111) crystal lattice. There are other suitable materials such as RuO₂, SrRuO₂ and (La, Sr)CoO₃, but Pt is by far the most common underlayer for PZT. Pt imparts an additional problem in that Pt does not adhere well to silicon-based substrates, and Pt also has the problem of diffusion with silicon, and oxidation with a SiO₂ layer. An intervening Ti layer can alleviate these problems, but Ti adheres poorly with most silicon-based substrates except for SiO₂. Thus, the preferred deposition process has initial strata of PZT/Pt/Ti/SiO₂/Si based substrate.

The following summarizes the some basic PZT layer formation methods including sol-gel, metal oxide chemical vapor deposition (MOCVD), and laser sputtering. The described processes are far from an exhaustive representation. However, most other deposition processes, notably hydrothermal and laser deposition are not known to have any substantial advantage.

Sol-Gel of CSD Processes

Sol-gel loosely refers to a solution suspended in a gel. In this case, the solution is made of the various PZT constituents. This can then be applied as a thick film (traditional) or a thin film in various manners. The standard thin film form of application is via spin coating. Thin films on the order 0.4 μm can be obtained with this approach. For a larger net film thickness, more layers are successively added, but the last layer applied must first be put through a soft bake to remove most of the suspension medium. The final net film is then typically put through a final anneal and poling.

Chemical Solution Deposition (CSD) can be considered either an alternative nomenclature for the spun on sol-gel process, or sol-gel is a subset of CSD. Sol-gel is more widely reported and more clearly defined, so the processes that were reported as CSD are lumped here under sol-gel. The following summarize some known sol-gel/CSD process.

Li, et al. “Electromechanical Behavior of PZT-Brass Unimorphs”, Journal of American Ceramics Society, Vol. 82, No. 7, p. 1733-174 (1999), which is hereby incorporated by reference in its entirety, used prefabricated PZT-857 unimorphs from APC. They performed the poling using transformer oil, T=100° C., E=2000 V/m, where the PZT thickness was 0.58 mm.

Bursill, et al. “Comparison of Lead Zirconate Titanate Thin Films on Ruthenium Oxide and Platinum Electrodes,” Journal of Applied Physics, Vol. 73, No. 3, pp. 1521-1525 (1994), which is hereby incorporated by reference in its entirety, prepared a PbZr₅₃Ti₄₇O₃ precursor solution in a metal organic solution of Zr-iso-propoxide, Ti-n-propoxide and Pb-acetate. 10% excess Pb was added to compensate for losses during crystallization. Solution was hydrolyzed to form the precursor at 0.4 M. This sol-gel solution was then spin coated onto the electrodes. The number of coatings and the spin rate were altered to obtain a final coating thickness of 0.4 μm. These films are then annealed into crystal at 650° C. for 30 min, in a quartz tube in air. They obtained (100) lattice planes oriented relative to the underlying surface, with a 50 nm thick non-crystalline layer. They did not report d₃₃ or d₃₁.

Zakar, et al., “Process and Fabrication of a Lead Zirconate Titanate Thin Film Pressure Sensor,” Journal of Vacuum Science and Technology A, Vol. 19, No. 1, pp 345-559 (July 1996), which is hereby incorporated by reference in its entirety, use PbZr₅₂Ti₄₈O₃ sol-gel spin coated onto platinized substrate, followed by RTA crystallization at 650° C. for 30 s in air. PZT thickness was 0.5 μm. They did not report d₃₃ or d₃₁.

Lee, et al. “Micromachined Piezoelectric Force Sensors Based on PZT Thin Films,” Journal of Applied Physics, Vol. 76, No. 3, pp. 1764-1767 (1994), which is hereby incorporated by reference in its entirety, use sol-gel precursors solution of PbZr₅₃Ti₄₇O₃ (0.4 M). Prepared by dissolving Pb acetate Pb(CH₃COO)₂ in acetic acid; then zirconium n-butoxide Zr(C₄H9O)₄ and then titanium tetra-isopropoxide Ti[(CH₃)₂CHO]₄ were added to the lead acetate solution. An extra 20 mole % lead acetate was added during solution preparation to compensate for lead loss during anneal. The solutions were hydrolyzed with an appropriate amount of water while ethylene glycol was added as the cross-linking agent to reduce the possibility of cracking. Solution was then further diluted with 2-propanol, 1-butanol, and acetic acid. The sol-gel is deposited by spin coating at 4000 rpm for 20 s. After each deposition, samples were dried on a hot plate at 110° C. for 5 min. Then they were heated to 600° C. for 20 min. A final perovskite anneal was done at 600° C. for 2, 4, and 6 h. The final PZT film consisted of 8 layers and was 1.2 μm thick. They did not report d₃₃ or d₃₁, but based their measurements on the assumption that d₃₁=−93 pC/N. Their average measurements were [symbol] _{DP}=4.33 MV/m, ε=1150.

Lefki, et al., “Measurement of Piezoelectric Coefficients of Ferroelectric Films,” Journal of Applied Physics, Vol. 76, No. 3, pp 1764-1767 (1994), which is hereby incorporated by reference in its entirety, compared the piezoelectric quality of sol-gel and MOCVD (see below). Their sol-gel mixture consisted of lead acetates and titanium and zirconium alkoxides. After each spin coating, the new film was baked at 600° C. for 30 min. Five coatings were applied for a total thickness 0.4 mm. This net film was fired at 700° C. for 1 hour. They poled the films with a 10 V field. The poled films had a d₃₃=400 pm/V. They also review the results from other researchers, which they summarize as a d₃₃ range of 150-250 pm/V.

Hoffman, et al., “Fabrication an Characterization of a PZT Thin Film Actuator for a Microelectromechanical Switch Application,” Materials Research Society Symposium Proceedings, Vol. 688, C5.9, pp 145-152 (2002), which is hereby incorporated by reference in its entirety, compared their analytical analysis, FEA, and experimental results of their cantilevered unimorph PZT micro-switch. Their 45/55 PZT layer was 350 nm thick. They measured [symbol] _{DS}=60 MV/m, d₃₁=−43 pC/N, ε_{T}=1151 for their devices. In Hoffman, et al., a subgroup of the researchers state that they conducted final anneal at 700° C. in O₂ for 5 min.

Iijima, et al., “Ferroelectric and Displacement Properties of Lead Zirconate Titanate Thick Films Prepared by Chemical Solution Deposition Process,” Materials Research Society Symposium Proceedings, Vol. 688, C10.5, pp 343-350 (2002), which is hereby incorporated by reference in its entirety, refer to their process as a low temperature CSD. Their final film thickness was 10 μm, which was obtained by repeating their process 5 times. Thus, their process lays down single layers that are 2 μm. They spun on their precursor solution onto a Pt/Ti/SiO2/Si substrate, at 3000 rpm for 40 s. Each newly applied layer was then dried at room temperature and then pyrolytically treated at 500° C. for 3 min. After the fifth layer, the samples were fired at 700° C. for 5 min. with an O₂ flow. An interesting result of their work was that a film thickness of 100 nm had the preferred (111) orientation, but that this orientation changed to (100) and (200) with increasing film thickness. They finally poled their samples with a conductive AFM probe at 100 V for 300 s, without using the top electrode. These finished samples had a d₃₃=115 pm/V.

Metal Oxide CVD (MOCVD)

There are various types of CVD, one of which, MOCVD, shows promise as a PZT deposition method. Lefki, et al. as noted above compared their sol-gel process to their MOCVD process. Their MOCVD process was performed at 700 C. and their corresponding film thicknesses ranged from 0.2 to 0.6 μm. They poled the MOCVD films with a 2 V field. These films had an unpoled d₃₃ of 20-40 pm/V, and a poled d₃₃=200 pm/V.

Plasma Sputtering

As stated above, plasma sputter is the preferred process since plasma sputtering forms a PZT layer that matches the underlying topology. In addition, plasma sputtering is the current state of the art in thin film deposition. Lefki, et al. note the results from another researcher of d₃₃=2.8 pm/V for a RF magnetron sputtering process.

Clifford F. Kollenburg, “Sputter Deposition of Piezoelectric Lead Zirconate Titanate Thin Films for Use in MEMS Sensors and Actuators,” Masters Thesis, University of California, Berkeley, Spring 2001, which is hereby incorporated by reference in its entirety, began with an ambient sputtering atmosphere of a 9:1 ratio of argon to oxygen (180 sccm:20 sccm) at a pressure of 2 mTorr and heated the wafer to 300° C. The wafer is on a carousel that is continuously rotating above the discrete targets for lead oxide, titanium, and zirconium. For an optimum 52:48 Zr to Ti film, the target powers were 60 W, 300W, and 185 W, respectively. This provided a deposition rate of 100 nm/hr, and a film thickness standard deviation of 27 nm for a mean thickness of 412.5 nm.

Contreras, et al., “Structural and Ferroelectric Properties of Epitaxial PbZr_{0.52}Ti_{0.48}O₃ and BaTiO₃ Thin Films Prepared on SrRuO₃/SrTiO₃ (100) Substrates,” Materials Research Society Symposium Proceedings, Vol. 688, C8.10, pp 303-308 (2002), which is hereby incorporated by reference in its entirety, use deposition rate of 12 nm/h. and a target having a Pb excess of 20%. Their optimized T_{substrate}=580° C. for an oxygen pressure of 3 mbar. They do not report d₃₁, and their process was for piezoelectric capacitors, thus the applicability of these parameters are suspect.

Reduction of PZT

The RAINBOW actuator requires reduction of PZT on one side to create differential expansion and dishing as described above. Some known processes for reduction of described below.

U.S. Pat. No. 5,589,725, entitled “Monolithic Prestressed Ceramic Devices and Methods for Making Same”, which is hereby incorporated by reference in its entirety, describes calcining at 975° C. for 2 hours in closed alumina crucibles. The milled and dried powders were first cold pressed and then hot pressed at 1200° C. for 6 h at 14 MPa. This yielded grain sizes of 5 μm. These were then sliced into individual pieces, and then ground and lapped. These pre-reduced pieces were then placed on a graphite block, which itself rested on a zirconia carrier plate. A second zirconia plate was placed on top of the wafer to protect that face from reduction. This assembly was placed into a furnace at 975° C. for 1 hour. The assembly was then removed and allowed to air cool. The cooled and now dished piece was lightly brushed to remove lead particles. The RAINBOW was then electroded with silver epoxy paint (5504N, E.I. du Pont de Nemours and Company, Wilmington, De.) at 200° C. for 30 min.

Wang, et al., “Determination of Young's Modulus of the Reduced Layer of Piezoelectric RAINBOW Actuator,” Journal of Applied Physics, Vol. 83, No. 10, pp 5358-5363 (1998, May 15), which is hereby incorporated by reference in its entirety, describe a process similar to Haertling's, but with a few variances. Wang et al. cut a Motorola soft PZT 3203 HD (5H-Type) into 55.0×15.0 mm×1.01 mm plates. The ceramic is then placed on a high-density flat carbon block with smooth surface finish. These are then heated to 975° C., at a rate of 300° C./hour. Other conditions are standard atmosphere. This is then held for 8 hours and then cooled at room temperature. These times and temperatures are modified to obtain the proper reduction depth. After second electrode layer was deposited, poling was done at E=2000 V/m and T=90° C. in transformer oil for 1 min. This gave a PZT thickness of 0.60 mm, and reduced layer thickness of 0.42 mm.

Wet Etching

The National Nanofabrication Users Network of Pennsylvania State University, which is hereby incorporated by reference in its entirety, describes wet etch processes. A 10:1 buffered oxide etch (BOE) of PZT forms a white crystalline layer. This white layer is removed with the final etch of a 2:1 HCL to deionized water. This is complete when the underlying metal electrode layer is visible. In their case, this underlying electrode is the standard Pt/Ti.

Dry Etching

Zakar, et al. etched in a Plasma-Therm 720 RIE, with an HC₂ClF₄ plasma. An angle of incidence 40° (not 90°) obtained the best sidewall slope of 70°. Photoresist (PR) was difficult to remove after PZT etching, so the PR was removed after etching the top Pt electrode layer. The Pt then acts as a mask. Rf power for PZT was less than 150 W, using an Ardel electrode shield, and an etch time of 20 min. Higher power can blister the Pt. They also provide a comparison of the Ardel electrode versus a graphite electrode. At the 150 W RF power line, the etch rate is roughly three times greater for the Ardel electrode.

Hoffman, et al. used an ECR-RIE process. To protect the resist they etched the first 100 nm with an Ar/O₂ plasma (5:1) at 300 V, p=8 μbar and T_{substrate}=−15° C. The corresponding etch rates: V_{PZT}=11 nm/min and vₛᵢ=13 nm/min. The final etching were etched with a CF₄/Ar plasma (5:1) at 250 V, p=4 μbar and T_{substrate}=−15° C. The corresponding etch rates: V_{PZT}=11 nm/min and v_{Si}=2 nm/min.

There are two steps that are not mentioned in the process plans because they are repetitive and minor. There are various cleaning steps. Plus, after each step film stress measurement should be made. An example measurement device is the Flexus Film Stress measurement machine.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. An actuator comprising:
a first region of piezoelectric material;
a support structure; and
flexures attaching a perimeter of the region to the support structure.

2. The actuator of claim 1, further comprising first and second electrodes on opposite faces of the first region.

3. The actuator of claim 2, wherein two of the flexures provide respective electrical connections to the first and second electrodes.

4. The actuator of claim 2, further comprising:
a second region of piezoelectric material; and
a third electrode, wherein the second electrode is between the first and second regions, the first electrode is on a side of the first region opposite to the second electrode, and the third electrode is on is on a side of the second region opposite to the second electrode.

5. The actuator of claim 1, wherein an electric field applied to the region causes crystal structure change in a plane of the region causing the region to dish, where in dishing provides a stroke of the actuator.

6. The actuator of claim 1, wherein the region is part of a bimorph.

7. The actuator of claim 1, wherein the region is part of a unimorph.

8. The actuator of claim 1, wherein a first side of the first region has piezoelectric properties that differ from piezoelectric properties of a second side of the first region.

9. The actuator of claim 7, wherein the first side of the region is chemically reduced.

10. The actuator of claim 1, wherein the support structure comprises a substrate underlying the region.

11. The actuator of claim 10, wherein the substrate comprises electrically conductive traces that the flexures electrically connect to the electrodes.

12. The actuator of claim 1, wherein the support structure comprises a frame surrounding the region.

13. An array of actuators having the recited structure of claim 1.

14. The array of claim 13, wherein the support structure for each actuator in the array comprises a frame having a hexagonal shape, and the frames are arranged in a hexagonal array.

15. An actuator comprising:
a region comprising a first layer of piezoelectric material that is between a first electrode and a second electrode; and
a plurality of flexures attached to a perimeter of the region, wherein the perimeter of the region is unsupported except where the flexures attach to the region.

16. The actuator of claim 15, wherein the plurality of flexures includes:
a first flexure providing an electrical connection to the first electrode; and
a second flexure providing an electrical connection to the second electrode.

17. The actuator of claim 15, wherein the region further comprises a second layer of piezoelectric material that is between the second electrode and a third electrode.

18. The actuator of claim 17, wherein the plurality of flexures includes:
a first flexure providing an electrical connection to the first electrode;
a second flexure providing an electrical connection to the second electrode; and
a third electrode providing an electrical connection to the third electrode

19. A deformable mirror comprising:
an array of piezoelectric actuators fabricated on a substrate; and
a mirror membrane attached to the array of piezoelectric actuators.

20. The deformable mirror of claim 19, wherein each actuator comprises a bimorph.

21. The deformable mirror of claim 19, wherein each actuator comprises a RAINBOW.

22. The deformable mirror of claim 19, wherein each actuator comprises:
a region of piezoelectric material;
a frame surrounding the region; and
flexures attaching a perimeter of the region to the frame.

23. A process for fabricating an actuator, comprising:
forming a sacrificial layer on a substrate;
forming a trench in the sacrificial layer;
depositing a first conductive layer over the first insulating layer;
patterning the first conductive layer to form a first electrode overlying the sacrificial layer and a first conductive trace extending from the first electrode into the trench;
forming a first disk of piezoelectric material overlying the first electrode;
depositing a second conductive layer overlying the first disk and extending into the trench;
patterning the second conductive layer to form a second electrode overlying the first disk and a second conductive trace extending into the trench; and
etching the sacrificial layer from under the first electrode.

24. The process of claim 23, further comprising reducing a top surface of the disk before depositing the second conductive layer.

25. The process of claim 23, further comprising:
forming a second disk of piezoelectric material overlying the second electrode;
depositing a third conductive layer overlying the second disk and extending into the trench;
patterning the third conductive layer to form a third electrode on the second disk and a third conductive trace extending into the trench.

26. The method of claim 23, further comprising depositing a first protective layer on the sacrificial layer and in the trench, wherein the first protective layer protects the first conductive layer during removal of the sacrificial layer.

27. The process of claim 26, wherein the first protective layer comprises silicon nitride.

28. The process of claim 23, wherein the first conductive layer comprises a layer of platinum and a layer of titanium.

29. The process of claim 23, wherein the first disk comprises PZT.

30. A process for fabricating an actuator, comprising:
forming traces on a substrate;
forming a first sacrificial layer overlying the electrical traces;
forming a first conductive plug and a second conductive plug through the first sacrificial layer, wherein the conductive plugs are electrically connected to the traces;
forming a first electrode overlying the first sacrificial layer, wherein the first electrode is electrically connected to the first conductive plug and electrically isolated from the second conductive plug;
forming a first disk of a piezoelectric material overlying the first electrode;
forming a second electrode on the first disk, wherein the second electrode is electrically connected to the second conductive plug and electrically isolated from the first conductive plug; and
removing the first sacrificial layer from under the first electrode.

31. The process of claim 30, further comprising:
forming a third conductive plug through the first sacrificial layer, wherein the third conductive plug is electrically connected to one of the traces;
forming a second disk of a piezoelectric material overlying the second electrode; and
forming a third electrode overlying the second disk, wherein the third electrode is electrically connected to the third conductive plug and electrically isolated from the first and second conductive plugs.
